(19) United States
(12) Patent Application Publication
(10) Pub. No.: US 2019/0043138 A1
(43) Pub. Date: Feb. 7, 2019

(54) SOCIAL FINANCE NETWORK PLATFORM

(71) Applicants: Bob Blake, Boca Raton, FL (US); Jonah Blake, Boca Raton, FL (US)

(72) Inventors: Bob Blake, Boca Raton, FL (US); Jonah Blake, Boca Raton, FL (US)

(73) Assignee: DebtMet, LLC, Boca Raton, FL (US)

(21) Appl. No.: 16/035,269

(22) Filed: Jul. 13, 2018

Related U.S. Application Data
(60) Provisional application No. 62/539,550, filed on Aug. 1, 2017.

(51) Int. Cl. G06Q 50/00; G06Q 20/10; G06Q 30/02; G06Q 20/34

(52) U.S. Cl. CPC G06Q 50/01; G06Q 20/10; G06Q 30/0234; G06Q 20/34; G06Q 30/0279

(57) ABSTRACT

A social finance network for college students and post-grad users who have accumulated debt, student loans and school related debt. The network being accessed through a client device, where the user is brought to a platform that contains their user profile, loan servicer info adjoined to the user profile, employment benefit information adjoined to the user profile, credit card info adjoined to the user profile. A profile on the social finance network uses a client device to access a suite of debt repayment applications, send payment directly to a loan servicer, host a student debt crowdfunding campaign, send money to another user profile on the network, direct message with other user profiles, purchase products through a credit card for a debt repayment rebate, debt management and payment breakdown of user profiles student debt, businesses offering debt repayment solutions on the social finance network, creation of a credit card with debt repayment incentives exclusively created in partnership with third party credit card companies.

### CROSS-REFERENCE TO RELATED APPLICATIONS

The present application claims priority to U.S. provisional application Ser. No. 62/539,550 filed on Aug. 1, 2017 entitled “SOCIAL FINANCE NETWORK PLATFORM”, the disclosure of which is hereby incorporated in its entirety at least by reference.

### BACKGROUND OF THE INVENTION

### 1. Field of the Invention

The present invention relates to a social finance network with a host of suite applications for repaying debt and college debt.

### 2. Description of Related Art

Undergraduate and graduate degree college students today face an increasing burden regarding the rising cost of attending school and debt costs and management. For most of these students, the cost of classes, books, housing, and increasing general necessary living expenses (while in a learning institution or after) are growing exponentially. The management of that cost and growth has not kept pace economically and is becoming unmanageable. The growth in the cost of education is further enforced by the widening gap between the changing qualifications that students need to enter the mainstream workforce and those that can afford to meet them. This leads to highly competitive internships that often do not compensate student educational expenses. This situation adds to the stress of being awarded a competitive internship, which often does not lead to a salary paying job or student debt reduction. This problem has created a college gig economy, where students go to school and career work by day and take skill tasked contracting jobs by night. While this gig economy for students and the younger generation is growing, no network hub with special or unique payment solutions (including blockchain and cryptocurrency payments) exist to facilitate this contracted work, which is typically used to pay off loans and school expenses. The youth gig economy that has arisen from the college debt problem will need a network and more sophisticated infrastructure that can facilitate methods for repaying loans and debts. These changes will need to be more readily organized than a typical company today would or can simply negotiate through a benefits program. Significant student debt structuring and payment is now a very complicated process that often requires not only the administration of learning institutions, but also loan servicers, different government agencies, debt restructuring companies, corporate student employment plans, banks and potentially many other separate loan and grant providers. It is a tedious and complicated process that is often not understandable for debtors.

There is not a network or a social network that provides a hub for incorporating all student loan necessary services or the ability to raise additional assistance funds and to work through the process involving all students on a single network. Moreover, there is no network that is secure or that incorporates all or very many of the needs of overall student loan servicing. Specifically, there is not one overall student debt repayment program or network hub that incorporates a blockchain ledger or offers other additional possible uses of currency and payment or such a secure network of communication. There is simply not a general social service or transaction mainframe to communicate between large groups of students or offers a variety of potential online opportunities to assist in the payment of student debt. The lack of any such “social finance” solution leads to a significant waste in time, expense, confusion and a loss of opportunity and potential repayment of capital. That is a significant cause of stress and losses for undergraduate and graduate students in today's market. The current methods are also often insecure methods that do not have a decentralized blockchain ledger and those old methods can lead to privacy issues, potential identity fraud and unnecessary loan servicing issues and a general inability to manage student debt without being at a significant economic disadvantage.

### BRIEF SUMMARY OF THE INVENTION

In one embodiment of the present invention a social finance network is fundamental for creating new methods of payment and repayment. In one embodiment, a social finance network is fundamental for offering incentive to repay debt. In another embodiment, a social finance network is fundamental for giving college students a simple, organized platform for paying back their loans. In one embodiment, a social finance network is fundamental for creating better employment benefits that are tailored to paying back debt. In yet another embodiment, a social finance network is fundamental for people that need a crowdfunding stage related to paying off debt. In one embodiment, a social finance network is fundamental for a payment mainframe that incentivizes paying off debt. In one embodiment, a social finance network is fundamental for new, existing or post university students that need to organize their finances. In another embodiment, a social finance network is fundamental for creating a platform that incentivizes financially giving back to a community. In another embodiment, a social finance network is fundamental for creating community and personal discussion that allows students and all others to interact personally with regard to education, finances and other relevant discussions and to create beneficial short term and lasting bonds, for both online or offline relationships. In yet another embodiment, a social finance network is fundamental for creating a platform with regard to new internet forms of payments and transactions such as blockchain technology applications and use of crypto currency in payment solutions for college debt, finances or purchases and financial transactions. In one embodiment, a social finance network is fundamental for creating a shopping hub that gives debt repayment incentives for making purchases. In one embodiment, a social finance network is fundamental for creating a competitive catalogue for people entering or transitioning in a job market.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 depicts an overview of the social finance network where working components such as user profile accounts, third party businesses, third party employers, crowdfunding, external servers, credit card with debt repayment, payment mainframe, social finance network platform, client devices and social finance network administrative server are integrated into one flowing network through a series of imported data and connectors according to one or more embodiments.

FIG. 2 depicts the overview of the social finance network with the added integrated technology of crypto currency and block chain, wherein a block chain creates a ledger of transparent and secure transactions that exist on the social finance network with the use of crypto currency as monetary value according to one or more embodiments.

FIG. 3 depicts the components of a block chain on the social finance network and the flow of transaction information between the social finance network platform, external servers, user profile accounts, credit card with debt repayment, client devices and social finance network administrative server according to one or more embodiments.

FIG. 4 depicts security protocol when crypto currency is used for transactions on the social finance network platform, wherein the security protocol is comprised of a public and private cryptographic key for a user profile account, the public cryptographic key consisting of user profile identifier, employer or employee identifier, public crowdfunding campaign identifier, or in combination thereof, the private cryptographic key consisting of user profile account issue code, student number or university code, employee code or number, credit card with debt repayment number or code issued, or in combination thereof according to one or more embodiments.

FIG. 5 depicts a welcome screen page which allows for login to an existing user profile or sign up, wherein a client device can register a new user profile account and access terms and conditions/library of agreements on a social finance network according to one or more embodiments.

FIG. 6 depicts an accept terms and conditions/library of agreements subpage for the authorization of creating or using a new or existing user profile account on the social finance network platform according to one or more embodiments.

FIG. 7 depicts a create new user profile account on the social finance network platform subpage where the import of external server accounts can be added to a user profile account as well as creating a new password, adding personalized additions to a user profile account, a save changes button for finalization of a new user profile account according to one or more embodiments.

FIG. 8 depicts a landing page for a social finance network platform where suite application tabs, feed and separate users exist on one mainframe according to one or more embodiments.

FIG. 9 depicts a subpage for a payment mainframe for the sending of bill payments to external servers attached to a user profile account on the social finance network platform with an outstanding balance. The outstanding balance being paid through crypto currency, credit card with debt repayment benefits, bank account or combination thereof according to one or more embodiments.

FIG. 10 depicts a send money subpage where separate user profiles, messaging transactions, transfers exist in this mainframe according to one or more embodiments.

FIG. 11 depicts an employer subpage where co-workers, feed, management contacts and employment benefits exist in this mainframe according to one or more embodiments.

FIG. 12 depicts a crowdfunding subpage where a user profile campaign, crowdfunder data, separate user profiles in relation to the campaign exist in this mainframe according to one or more embodiments.

FIG. 13 depicts a student debt lender subpage for transaction and transfer directly to an outstanding loan according to one or more embodiments.

FIG. 14 depicts a login and signup mainframe for employers and HR executives to activate a team leader interface on the social finance network for user profile accounts that have imported employment data and are eligible for employment benefits according to one or more embodiments.

FIG. 15 depicts a management information relay chart that represents the components of a team leader interface on the social finance network according to one or more embodiments.

FIG. 16 depicts a team leader/human resources executive subpage, wherein management, debt repayment, sending messages to employees exists in the team leader interface on social finance network platform according to one or more embodiments.

FIG. 17 depicts a monthly objective subpage where team leader/human resources can post objective goals and timelines as well as monitor objective progress while in the team leader interface on the social finance network platform according to one or more embodiments.

FIG. 18 depicts a subpage for an attached credit card for purchasing and debt repayment purchasing and all transfers, transaction, payments, purchases on a social finance network platform. This also demonstrates a visual representation of the credit card with debt repayment benefits for employers, employees, or common users or in combination thereof; wherein the card is given to a user profile account by an employer, visual representation of the card can view credit allowance from employers, support info for managing the credit card, the allotted amount allowed to spend from an employer, a button to make a purchase with the credit card as a user according to one or more embodiments.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a heating coil for a social finance network.

The present embodiments relate to a social finance network platform for repaying loans, repaying debt, receiving debt related employee benefits, payment mainframe for clients to loan lenders, promoting crowdfunding campaign in relation to paying off debt, making product purchases thorough a credit card with debt repayment rebate, creating an online community centered around financial responsibility by using a network based program that can be in an administrative server or external server connected to client devices.

The social finance network can be computer radium medium, which can be referred to herein as the “debtmetsocial” network.

The social finance network can create a unique platform for debt repayment, crowdfunding, transfer and transaction of payment and bills, incentivize greater benefits for new or existing employees within a company and design a community centered around financial well-being.

The social finance network can support a user profile holding debt by structuring a clean platform to organize all said user's financials related to the debt. This allows the user profile to make various debt payments and decisions that were accrued from multiple third-party sources on one mainframe with the click of a button.

The social finance network can develop a customized mainframe within the platform that encourages user profiles to set amounts per month at which they want to transfer money from a bank account to a loan lender for the eventual repayment of their debt. They can view the actions of paying off this debt thorough a structure on a platform that holds their day to day data relative to crowd funding, purchases thorough a credit card with debt repayment incentives, debt repayment employment benefits, transfer and collection of money from separate user profiles. This will create a system for encouraging more activity on the network. In one embodiment, the monetary amount can be an amount of money, such as an amount in euros, us dollars, crypto currency and another form of currency, or the like.

The social finance network can benefit the future and existing generations of people in the united states by creating more wealth, reducing the default rates on debt, promoting financial awareness, creating a digital community for economic and education acknowledgment, increasing the rate at which people are likely to attend college, create a more financially sensible infrastructure in relation to the cost of university attendance and creating new methods of payment or benefit the current systems of payment.

The social finance network platform has a function and mainframe for collecting and distributing money for debt repayment, where this money collected comes from is debt repayment employee benefits, transfer of money between separate user profiles using a client device, purchase of products and services while in the platform using an attached credit card with debt repayment incentives, third party promotions that exist in the platform feed, crowdfunding campaigns on the platform. This function is enabled through an administrative server or external server to network being accessed through a client device.

The social finance network administrative server or cloud based server with processor and data storage can have numerous computer instructions stored in their respective databases connected to processors. In embodiments, the social finance network can be partially resident in the computing cloud data storage, partially resident in a non-cloud based administrative storage, and partially resident in data storage of a client device with a processor.

The computing cloud, according to an embodiment of the method can have one or more data storage units and one or more processor with data storages, and can be configured to provide at least one service and shared hardware and software resources for a plurality of client devices.

In particular embodiments, at least one processor with data storage in the computing cloud can be configured to collect information provided by the clients to determine the best promotions to offer, most relatable effective product purchases with debt repayment incentives, analyze general user activity on the social finance network platform.

In embodiments, at least one processor with data storage outside of a computing cloud can be configured to collect information provided by the clients to determine estimated date of full debt repayment based upon selected money amount to be billed monthly, purchase of products and services with debt repayment incentives, current employment and debt repayment benefits offered, current or past college attendance.

In other particular embodiments, at least one data storage unit in the computing cloud can be configured to store the information associated with the user profile on the social finance network platform.

“User profile” as used herein can refer to the following with student debt or a debt in need of repayment: a college student, a parental guardian, a post-college user, employee, employer, any member or co-signer associated with a debt that is deemed liable for payments.

In yet other particular embodiments, at least one processor with data storage in the computing cloud can be configured to process data associated with purchasing and payment routines within the social finance network platform absorbed by the client device hosting a user profile account on the platform. In addition activity patterns within the social finance network platform absorbed by the client device hosting a user profile account on the platform. Crowdfunding data within the social finance network platform absorbed by the client device hosting a user profile account on the platform. Use of employment benefits within the social finance network platform absorbed by the client device hosting a user profile account on the platform.

At least one processor with data storage can use the data associated with user profile activity and traffic on the social finance network platform to adjust mainframes, payment systems, product incentives in relation to debt repayment.

In embodiments, a notification can be given the directive of creating signals on a user profile in a social finance network platform to identify when a bill or payment needs fulfillment, has been fulfilled or is approaching fulfillment.

In one or more embodiments, at least one processor with data storage can be configured to recognize a user profile's customized setting and routine on a social finance network platform for giving a timetable bracketed into monthly installments at which said user's debt will be fully paid.

The platform can include computer instruction and operation for quantifying money or crypo currency amount total a user profile account on a social finance network platform has acquired from making product and service purchases on the platform using a credit card with debt repayment incentives instantly upon transaction.

The client devices can be a mobile phone, a smart phone, a computer, a tablet, a computer, a laptop computer, augmented reality machines, virtual reality machines, university terminals, third party business terminals, government terminals, smart tv, smart home appliances, artificial intelligence platform or another communication or display device.

The computing cloud can communicate with other computing clouds over the network, such as computing clouds with social media services, block chain's, computing clouds with financial services or the like and with other networks.

In an embodiment, the platform can be operated on both a computing cloud and a local network simultaneously. The local network can be used to acquire a user profile transaction, purchasing, crowdfunding, social media interaction and debt repayment activity information and in embodiments, the computing cloud can be used to processes the information in accordance with the total of user profile accounts that exist on the social finance network platform.

A feature of the platform is to construct user profile activity history giving the ability to monitor, storage, and label financial data for the user profile account on the social finance network to keep and view an organized log of their financial accounts.

Modern Americans in debt or entering as consumers in the economy need a platform that consolidates the complexities of paying off debt and self-managing fiscally. They need a digital community of similar individual with the goal of helping each other. They do this through a social finance network with applications that allow raising money, managing money, receiving benefits for work, easy access to payment portals for debt repayment, sending money across a similar community. Using a social finance network to reach all modern devices will capture millions of people that need help financially.

The social finance network platform can form an easy to use base for both monitoring financial actions and act as a network server housing storage of the data to manifest more accurate day to day economic readings, for example using collected community routines and actions from user profiles on the social finance network platform to create an algorithm that gives an estimation of the current state of the U.S. Economy or the U.S. Debt statistics.

The social finance network platform can allow information from the student loan holders to be reviewed and analyzed. This provides for faster resolution of user issues. The social finance network platform can include hyperlinks to social media services within the social finance network feed, such hyperlinks could include Twitter®, Snapchat®, Facebook®, Linkedin®, or similar services to promote crowdfunding campaigns, debt repayment initiatives, product promotions, third party promotions, user profile's exclusively on a social finance network cross platform messaging other users on another servers, user profile's exclusively on a social finance network sending or receiving money cross platform from another user on another network.

The social finance network platform can use a network that can be a satellite network, a cellular network, the internet, a wireless network, a wired network, a phone line, any communications network, a blockchain such as Bitcoin or Ethereum or combinations thereof. The network can connect the client devices to the cloud computing processor and data storage and the administrative processor and data storage.

In embodiments, a user profile exclusively on a social finance network platform can personalize a login with a profile indicator and password for access to the platform.

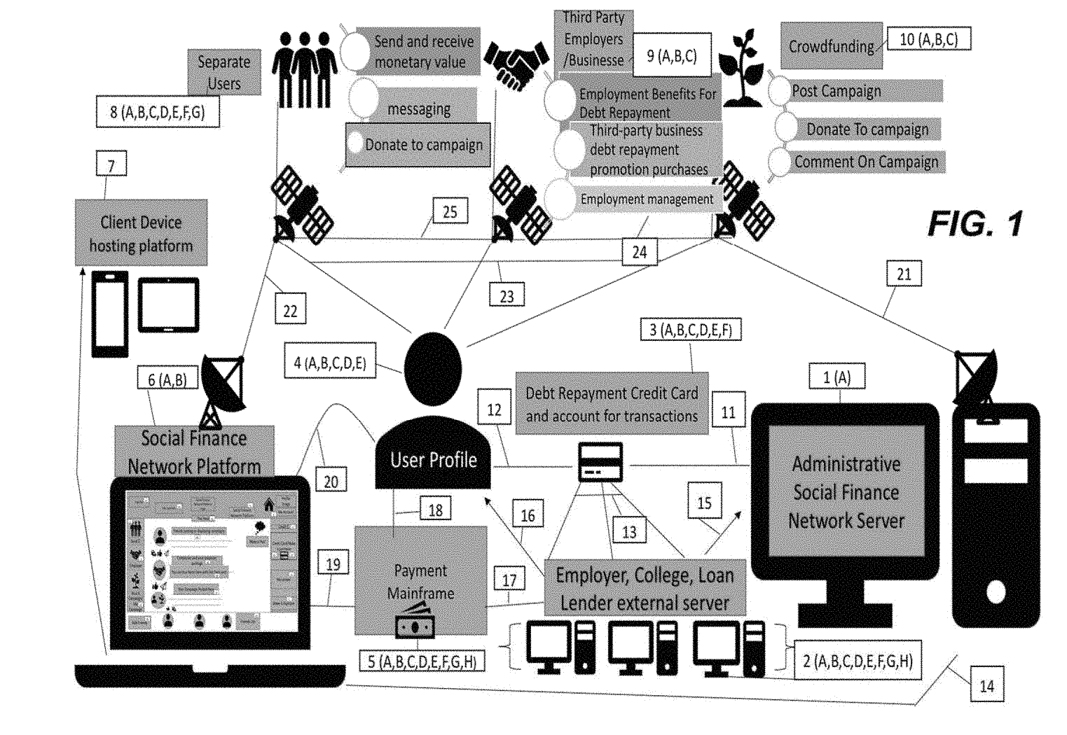

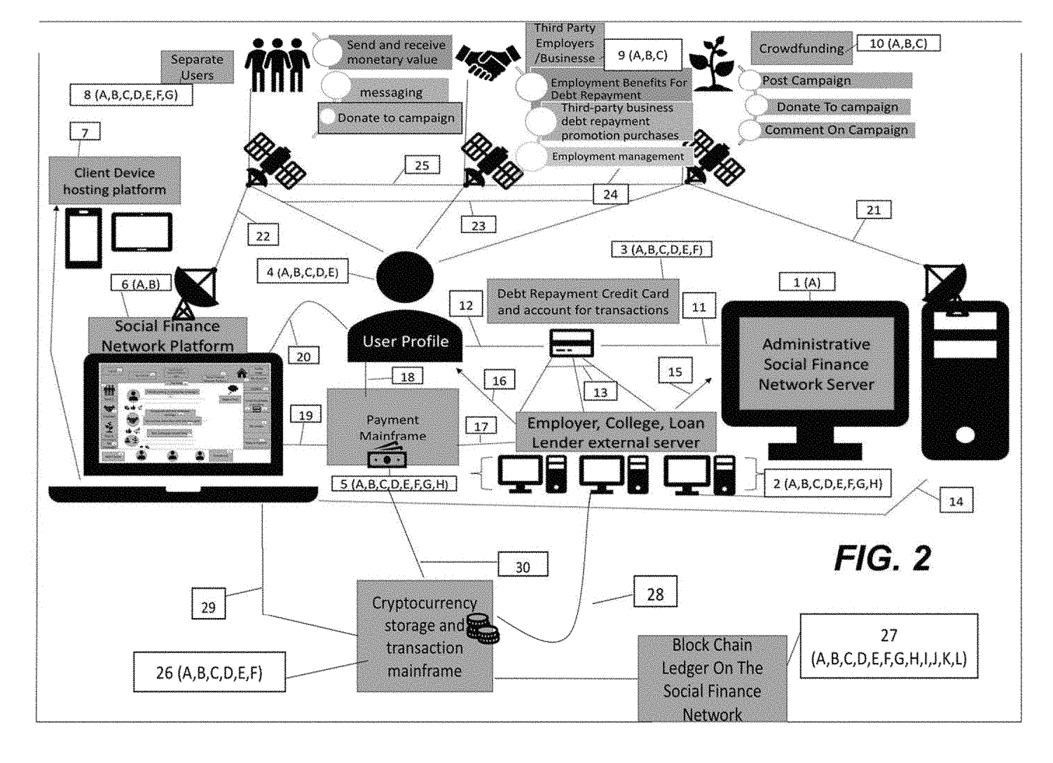

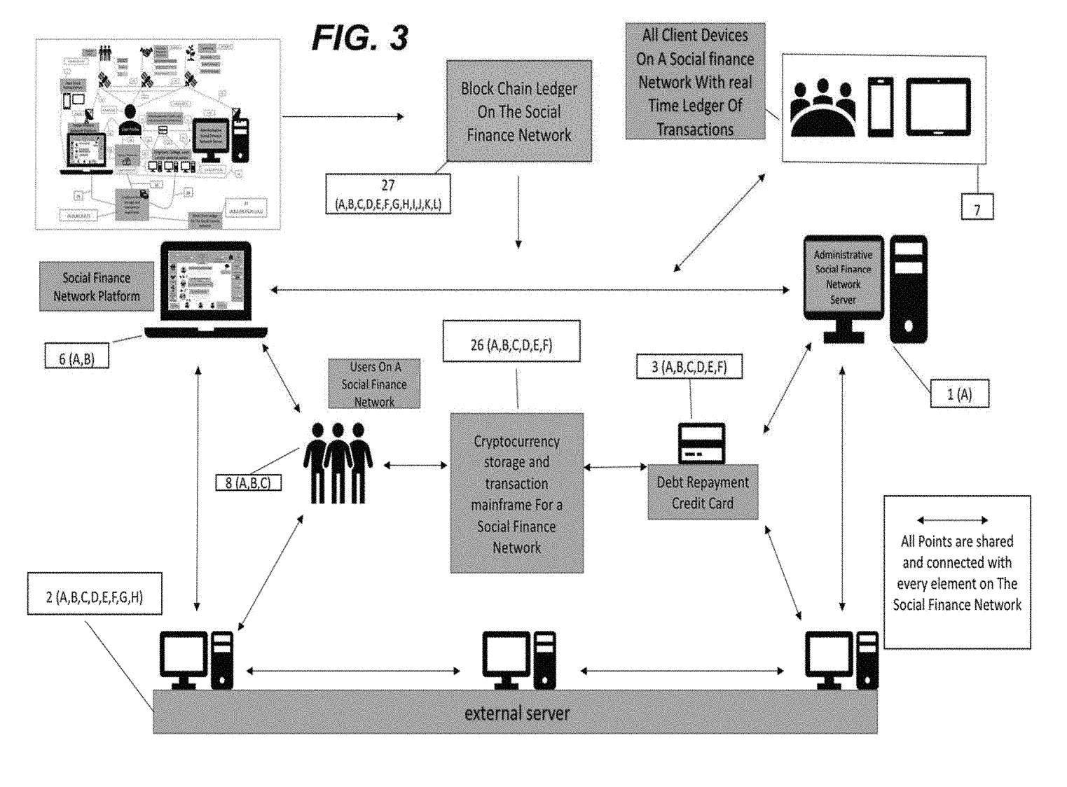

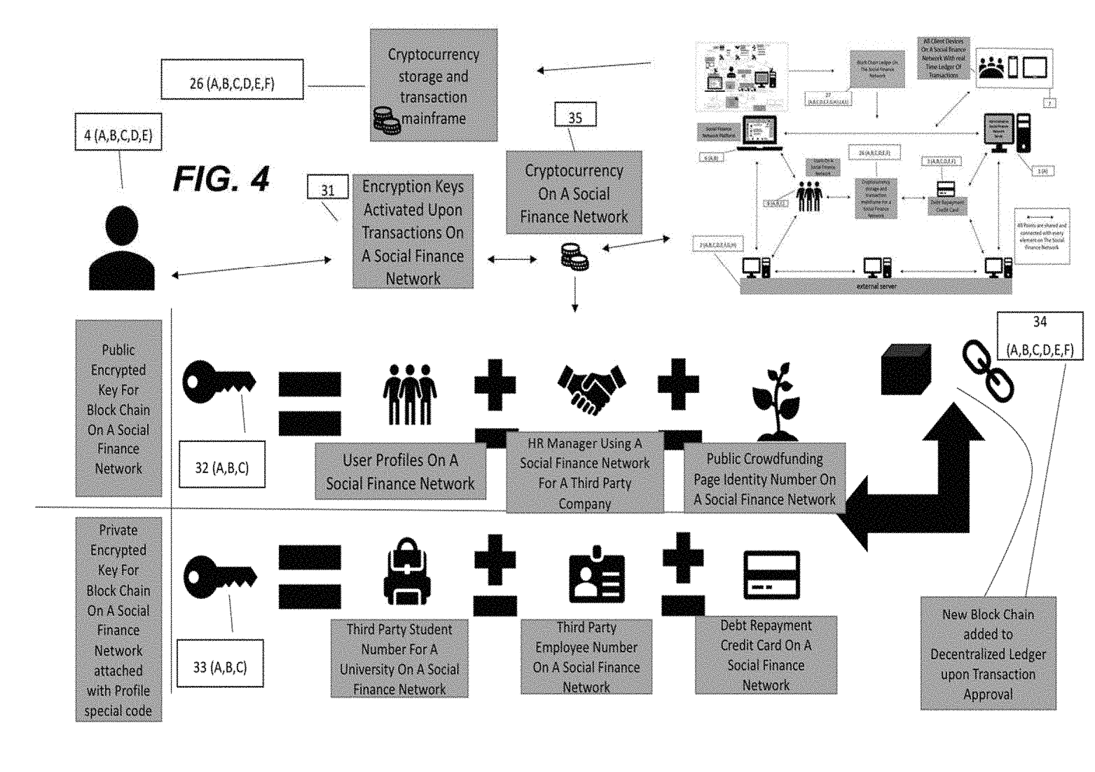

Turning now to the figures, FIGS. 1, 2, 3 and 4 depicts an overview of the social finance network and the addition of crypto currency with block chain technology according to one or more embodiments. The social finance network platform (6) can connect to a client device (7) hosting a user profile and a network administrative server (1) in communication with a network. The network can communicate with a computing cloud with cloud data storage and other such devices that can communicate with each other. The cloud data storage (1a) can contain computer instructions to process information on one or more accounts for storing money (3) (5). The client device (7) can have a processor and data storage for displaying data relative to the account deemed the user profile (4). The data can be presented on a mainframe or other such device.

In one embodiment, the social finance network can include employment benefits (2c), university benefits (2b) one or more student college loan profiles, each having an amount of money to be repaid (2a). The accounts can be linked to the user profile (16) (4) on a social finance network platform (6) for attaining money (3) (5), the client device (7), the administrative server (1), or combinations thereof through the network.

In operation, the accounts with imported data from (2a, 2b, 2c, 2d, 2e, 2f, 2g, 2h) can be configured to send payment (5) or receive deposits from the accounts (3) (5) into one user profile (4) exclusively on a social finance network platform (6). User profile accounts (4) with the function of collecting money (13) (12) (3) (5) can collect from the following sources and direct them into accounts on the social finance network platform (6): credit card accounts with the operation of having a debt repayment incentive (3a) (63), direct deposit network accounts (3b), university administered monetary value or money (2b) (5), third party employer benefits in the form of monetary value (2c) (9a), social finance network credit (3c) (63), loan lender (2a) (5).

An application marketplace for client devices, for example android and apple marketplaces, can be in communication with the social finance network platform (6) for access to a downloadable application that connects to the social finance network platform on one or more client devices (7).

The client device (7) has a processor and data storage and is adapted for storing the social finance network application “debtmetsocial” (6) and permitting a user profile (4) on the social finance network platform (6) to view the client device portion of the network (7). Two or more friends, family, co-workers, university students, product buyers and sellers, service buyers and sellers that have user profile accounts (4) exclusively on the social finance network platform (6) can transmit messages within the network (22) (8b) and use this functionality for acquiring money (3) (5), sending money (18) (5), crowdfunding (10), employee benefits (9a), job search (9), product purchasing (5a), service purchasing (5a), debt repayment mediums (3a, 3b, 3c, 5e, 5g).

A third-party business (9) with authorization to promote or conduct trade on the social finance network (1) (6) can be given the operations functionality to communicate on the feed of the social finance network platform (6a). A third-party business (9) with authorization to promote or conduct trade or manage employed (9c) (61) users (4) on the social finance network platform (6b) can be given the operations functionality to communicate with employees (61b) (4a), perspective employees (4a), interns (4b), general user profiles (4) of the social finance network platform (6) with an access function to send money (23) (4) (12) (3) (5) (61a), manage employment benefits (2) (16) (4) (61a), create promotion for perspective employees (9), manage interns (4b) between university profiles (2b) (16) (4) with intern incentives on the social finance network platform (6), create promotions related to university (6b), debt repayment (3) (61a) (63), product purchases offering incentive (9b).

Following permission from the administrative server of the social finance network (1), a third-party business (9) can conduct all permitted operations on a business user profile account (4c) on the social finance network platform (6) which can be operated by a selected employee or employees (4c) (61) (62) (63) of that business and represented by the logo of the company (9). Once this account is registered, the business may be given clearance to conduct operations related to transferring money (23) (5) (3) to any user profile account (4) (12) (3) (5) with permission of a user profile account (4) that receives the transfer (23) (5), display and promote products for purchase in a mainframe that exist exclusively on the social finance network platform (9) (22) (6) (5), sending promotions and agreed incentives attached to a product once purchased by a user profile account on the social finance network platform (9) (22) (6) (20) (4).

A third party can be in communication with the network. (2d) that third party can be a government agency or bureau, such as the social security administration, a student administration network, fafsa or another third party.

In an embodiment, any third-party business or employer (9) with authorization from the social finance network administrative server (1) can send user profile accounts (4) exclusively on the social finance network platform (6) promotions, offers, incentives. The promotions, offers, incentives can be monetary incentives, crypto currency offers (2e), discounts, benefits, or combinations thereof.

In one or more embodiments, the third-party business or employer (9) can be an employer of one or more of the user profile account (4) exclusively on the social finance network platform (6), and can transfer employment benefits related to the operation of repaying debt (9) (22) (6) (20) (5) directly to a user profile's (4) attached loan lender (18) (17) (2a) on the social finance network platform (6). The employer can provide discretionary additional deposits of preset or non-preset amounts of money as payment on a loan lender bill or directly to the user on a user profile (4) exclusively on the social finance network platform (6) is due.

For example, if a user profile account (4) exclusively on the social finance network platform (6) has been given authorization by an employer account (2c) attached the user profile's information (16) (4d) to receive employment benefits related to paying back debt (3) (61) (61a), the employer (9) may be allowed to transfer a monthly or yearly allowance of money or monetary value from an account (9) (23) (4) (61a) (5) on the social finance network platform (6) to a loan lender requesting said user profile's debt be paid off in certain installments (2a). This entire transaction being conducted on debtmet's social finance network platform and payment mainframe (6) (19) (5).

If an employer with an account (9) exclusively on the social finance network platform (6) desires the function to send money or monetary value (23) (5) to an employee with a user profile (4a) account exclusively on the social finance network platform (6) not related to employment benefits and purely for compensation based on goals achieved in the company, the employer (9) may be given the operations function to convert the money or monetary value into “debtmet credits” (62) (62a) (62g) which have equal money or monetary value only on the social finance network administrative server (1). A user profile account (4) given “debtmet credits” may use this form of compensation for all product or promotion purchases (4) (23) (9b) on the social finance network platform (6).

The employer account (9) exclusively on the social finance network platform (6) can initiate an operation function to contribute money or monetary value (9) (24) to any crowdfunding campaign (10) that is created by a user profile account (4) on the social finance network server (1) and promote a crowdfunding campaign (10b) attached to any employee user profile account (4a) that has information associated with the employer.

The employer account (9) exclusively on the social finance network platform (6) can initiate an operation function to donate money or monetary value (23) (4) (5) to a loan lender debt repayment related to an employee user profile account (4a) exclusively on the social finance network platform (6). This donation may be any money amount or contribution equal to the monthly installments a debt is repaid.

The university admin account (2b) exclusively on the social finance network platform (6) can initiate an operation function to contribute money or monetary value (10b) (5) (5e) to any crowdfunding campaign (10) that is created by a user profile account (4) on the social finance network platform (6) and promote a crowdfunding campaign (10c) attached to any user profile account (4) that has information associated with the university servers (2b).

The university admin account (2b) exclusively on the social finance network platform (6) can initiate an operation function to donate money or monetary value (16) (5) to a loan lender debt repayment related to a user profile account (4) (12) (3) exclusively on the social finance network server (1). This donation may be any money amount or contribution equal to the monthly installments a debt is repaid.

The administrative server of the social finance network (1) can perform the operation of sending notifications to the mainframe of a user profile (4) (18) (5) exclusively on the social finance network platform (6) on any form of client device (7). In one embodiment, the social finance network administrative server (1) can initiate an operations function to show the user profile account (4) exclusive on the social finance network platform (6) with a platform interface to any client devices (7). In one embodiment, the social finance network administrative server (1) can initiate operations function to connect the user profile accounts (4) exclusively on the social finance network platform (6) to login to the platform (38) which is partially resident in the computing cloud data storage, partially resident in the administrative server, and partially resident on a client device using: a new, exclusive and created user profile and a new, exclusive and created password (4d).

In one embodiment, the social finance network administrative server (1) can perform operations functions to view the social finance network through a client device application from an application stored, which is partially resident in the computing cloud data storage, partially resident in the administrative server, and partially resident on a client device, allows the client device application to communicate with the platform via the overall network.

In one or more embodiments, the notifications can inform a user profile (4) exclusively on the social finance network platform (6) of a new product with debt repayment promotion (9b) based on said user profile's purchasing and activity history (5) (4) on the platform (6a). If the user profile (4) receives this notification and purchases the promoted item that also offers debt repayment incentive amounts (9b), the user profile account (4) exclusively on the social finance network platform (6) will receive this debt repayment incentives amount instantly and be transferred as a reduced amount on a user profile's entire debt that is attached to their account (5) (3) (3c). For example, the notifications can present a new product related to education that also offers a debt repayment promotion (9b) to a user profile (4) exclusively on the social finance network platform (6) that has had past activity related to the product and subject of education (4) (4a) (4d).

Addition to the previous example, if the user profile (4) exclusively on the social finance network platform (6) has decided to purchase this education item with debt repayment promotion (9b), the social finance network administrative server (1) or external server (2) or both can send operations to the user profile (15) (16) purchasing the item to agree to the terms of the promotion, if agreed, the debt repayment promotion (9b) amount listed in the notification is sent directly into the debt owed by the user profile (4) (4d) (5), automatically reducing the overall debt left to pay off that account (2) (5).

Operations functions in the social finance network's server (1) can provide a user profile (4) exclusively on a social finance network platform (6) with a user mainframe (4), which portrays data in relation to the amount of debt reduced from purchasing products or services (9b) and both exclusively from the social finance network platform (6).

Operations functions in the social finance network's server (1) can provide a user profile (4) exclusively on a social finance network platform (6) with a user mainframe (4) (5), which portrays data in relation to the amount of debt reduced from using a social finance network related credit card that offers debt repayment incentives (63).

The information from a user mainframe (4) (4d) on the social finance network platform (6) can view, progress towards debt repayment, money amount saved since creating a user profile (4), amount saved from purchasing products on the platform (9b) (5), amount saved from purchasing services on the platform (9b) (5), amount saved since signing up for a social finance network related credit card with debt repayment incentives (3a) (63), social finance network credits accumulated for use of purchases (3c), awards earned from activities that exist on a user profile, university savings from using the platform (2b), employment benefits amount accrued from an employer (4a), amount of people the user profile has helped or donated to since creation of the profile (8c), amount of money accrued from a hosted crowdfunding campaign (10a).

The social finance network administrative server or cloud data storage (1) (1a) can include computer instructions to configure the client device application to be operable while connected to the network and while disconnected from the network.

In operation, the user profile (4) accounts as part of the social finance network (1) can use the input architecture of the client device (7) to operate the client device network platform application (6) for communication with the computing cloud (1a), the administrative server (1), and combinations thereof to store information on the accounts for accumulating, depositing, transferring or acquiring different forms of currency (3b)(5a)(5b) (5g) (5h), and accounts (4) (3c) (3e) (61) (4a).

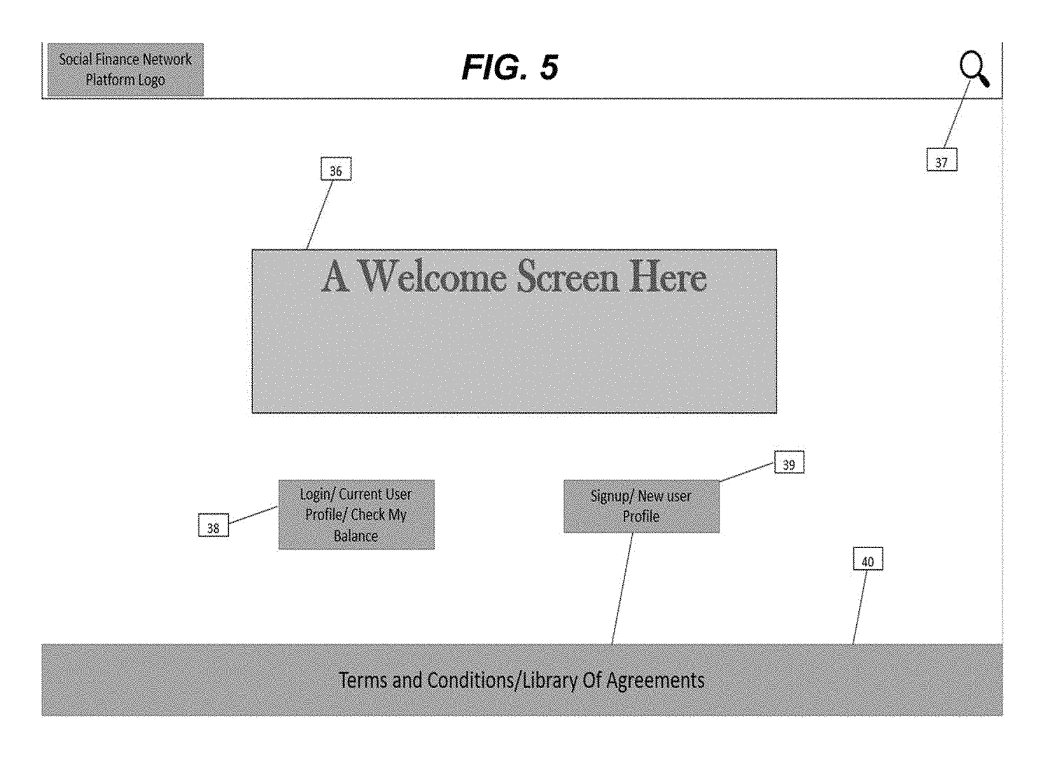

FIG. 5 depicts a welcome screen page which allows for login to an existing user profile or sign up, wherein a client device can register a new user profile account. The home login page of the social finance network platform allows client devices (7) (36) to login to the social finance network platform (6) and connect to the network using a user profile (4) exclusive to the social finance network platform (6) with a password created on the platform (6) (4d). The home login page of the social finance network platform allows client devices (7) (36) to login to the social finance network platform and connect to the network using a user profile (4) created by a university admin (2b) and made exclusively for the social finance network administrative server (1) with a password created on the platform (6) (4d).

In one embodiment, the home login page of the social finance network platform allows client devices (7) (36) to login to the social finance network platform (6) and connect to the network using a user profile (4) created by an employer admin (2c) and made exclusively for the social finance network administrative server (1) with a password created on the platform (6) (4d). In one embodiment, the home login page of the social finance network platform allows client devices (7) (36) to login to the social finance network platform (6) and connect to the network using a user profile (4) created by a loan lender (2a) for a loan borrower and made exclusively for the social finance network administrative server (1) with a password created on the platform (6) (4d).

In one embodiment, the login page in the client device (7) (36) (38) can allow the user profile account to login to the client device viewable platform (6) and connect to (14) the network using a client device (7) while using a password (4d). In one embodiment, the welcome screen on the social network platform (6) (36) allows for engagement with users (8) connection to third parties (9), crowd funding (10), loan lender external server links (2a), employer external server links (2c), university external links (2b), government external links (2d), crypto currency external links (2e), credit card company external links (2f), bank external links (2g) and social media external links (2h). In one embodiment, the welcome screen on the social finance network platform (6) (36) can include deposits on the user profile account (38) (3b) and debt repayment incentive credit card (3a). In one embodiment, the welcome screen (36) can include accrued social finance network credits (38) (3c). In one embodiment, the welcome screen (36) can include product and service purchases made by a user profile on the social finance network (38) (3d). In one embodiment, the welcome screen (36) can include an accumulated amount in received incentives from a debt repayment credit card (38) (3e).

On the social finance network platform (6) the links and selectors in the welcome screen (36) can enable the user account holders (4) to transmit information and commands to actuate the computer instructions therein. As such, in operation, when individual users use links or selectors in the welcome screen (36), the client device (7) can activate computer instructions in the computing cloud data storage or the administrative data storage (1a) to perform associated actions, such as initiation of a transfer or receipt of payments (5) (3f).

The links and selectors can be touch screen buttons presented by the user profile account (4) holder interface or other links or selectors on the client device (7).

In one embodiment, the social finance network administrative server (1) can use cloud data storage (1a) for recognizing a client device (7) that logs into a user profile account (38) (4) on the social finance network platform (6) at normal intervals.

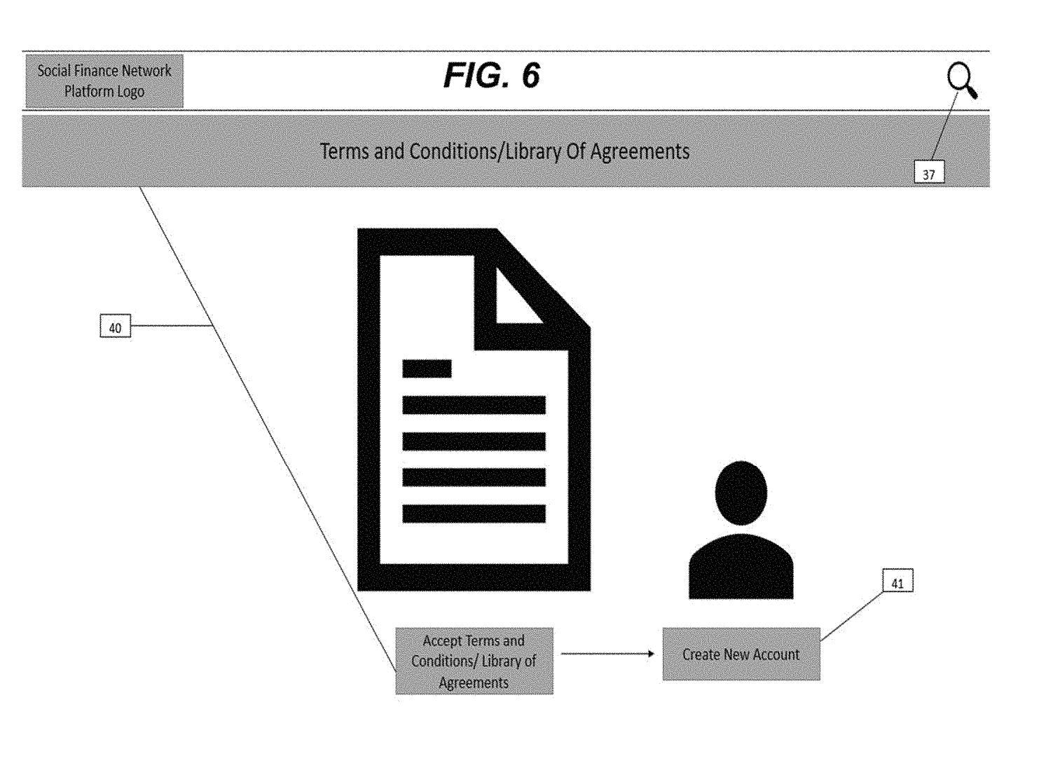

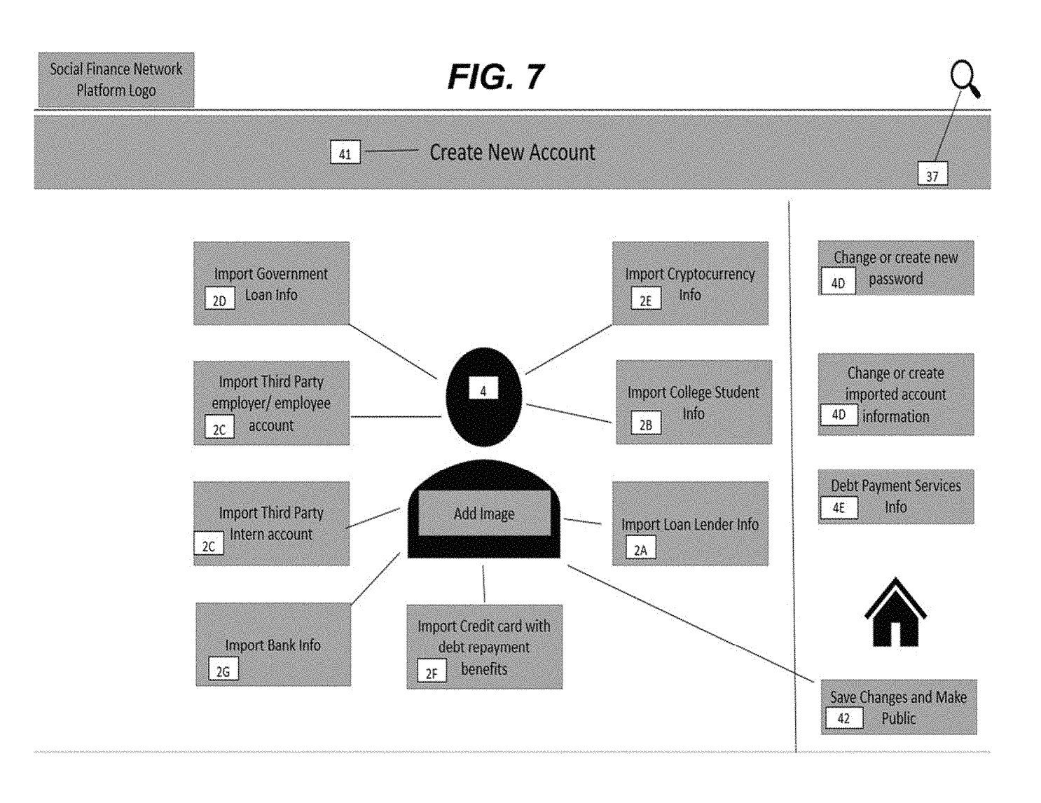

FIGS. 6 and 7 depicts an accept terms and conditions/library of agreements subpage for the authorization of creating or using a new or existing user profile account and the subpage for creating a new user profile account with imported external server data. In one embodiment, a financial responsibilities agreement and other forms of agreements documentation (40) is given to a newly created user profile account (4) (41) exclusively on the social finance network platform (6) to that have logged into the network for the first time which is partially resident in the computing cloud data storage, partially resident in the administrative server, and partially resident on a client device or any combination thereof. Agreements altered by the social finance network administrative server (1) will be digitally sent for renewal of agreements to an existing user profile account (4) on the social finance network platform (6). In one embodiment, a financial responsibilities agreement and other forms of agreements documentation (40) can be displayed within the user profile account back-end information (4d) after initially agreed upon by the user profile account (4). The user agreements section (40), which will be a part of the footer of the welcome screen (36) of the social finance network (6) will present various agreements from a library of agreements (40) in one of the data storage servers. A signup agreement and other forms of agreements documentation (40) is displayed before the creation of a new user profile account (41) (4) exclusively on the social finance network platform (6).

In one embodiment, an account integration for user profile account (41) (4) exclusively on the social finance network information agreement (40) is displayed upon creation of a new user profile account (41) (4) exclusively on the social finance network platform (6). This account integration agreement is relative to university (2b), loan lender (2a), government (2d), third party business (2c), crypto currency (2e), credit card company (2f), bank (2g), separate social media service (2h) or all the above that will import information into the exclusive user profile account (41) (4).

In one embodiment, an employer account (2c) to employee user profile (4a) (9c) for transfer of employment benefits agreement (5) (61a) is displayed upon the action of an addition where employer benefit and employer connection is made on an existing user profile account (4) exclusive to the social finance network administrative server (1).

In one embodiment, a university authorization of information agreement (40) is displayed upon the action of an addition where university attendance and other account information (2b) and user profile (4) registered on the social finance network connection is made. In one embodiment, a loan lender responsibility and transfer of payment agreement (40) is displayed upon the action of an addition where third party loan lender account (2a) information and other account information is uploaded and a user profile account (4) exclusive to the social finance network connection is made.

In relation to activities and connection established with user profile accounts (4) exclusive to the social finance network platform (6), the loan lenders (2a), university administration (2b), government and government officials (2d), cryptocurrency distributors (2e), third party businesses (2c), credit card companies (2f), banks (2g), select social media services (2h), all of the above are required to sign policies and agreements in accordance with user profile activity (4) (4a) (4b) (4c) (4d) (4e), protection laws, financial responsibilities or any agreement (40) that establishes their responsibilities while active on the social finance network platform (6).

In relation to any product, service, suite application manifested by the social finance network administrative server and platform (1) (6) and is deemed exclusive to the social finance network and its' platform, loan lenders (2a), university administration (2b), government and government officials (2d), cryptocurrency distributors (2e), third party businesses (2c), credit card companies (2f), banks (2g), social media services (2h), all of the above are required to sign authorization in accordance with agreements (40) for licensing, trademark, product use, service use or any agreement at which the social finance network deems needed for the partnership.

The social finance network administrative server (1) can perform operations functions to import data from a loan lender (2a), third party employer (2c), credit card with debt repayment incentives (3), university to the user profile account made exclusively for the social finance network platform (2b), government data relative to a user profile account (2d), crypto currency owned by a user profile account (2e), credit card company data (2f), banks attached to a user profile account (2g), external social media service links (2h) (6a) which is partially resident in the computing cloud data storage, partially resident in the administrative server, and partially resident on a client device (7).

The social finance network administrative server (1) can perform operations functions to create a new, exclusive and created user profile account (4) with name and profile image icon (4c) (4d) and new password for the social finance network platform (4d) (6) using the client device application preloaded onto the client device (7), and allow for manifestation of the created user profile account (4) separately from a pc terminal and enable a login (38) and platform for access on various mediums.

In one embodiment, the social finance network administrative server (1) can perform operations functions to import (15), receive and store financial information (2) (15) (16) selected by a user profile account (4) exclusively on the social finance network platform (6). For example, the financial information can include a name of a loan servicer, college, government agency, third party employer, crowdfunding account, blockchain, credit card, crypto-currency or any financial institution managing the account, such as a name of the account holder operating any financial account of the user or loan holder's; an account number associated with the account, such as a financial institution account number; and other information related to the account, thereby allowing the platform interface (6) which can be partially resident in the computing cloud data storage, partially resident in the administrative server, and can be partially resident on at least one client device to access the user profile (4) account for linking to the account for managing, paying and receiving money.

In one or more embodiments, the user profile account (4) exclusively on the social finance network platform (6) can have a university student number for management with a selected university admin (2b). The cloud data storage (1a) may also include the agreements link (40) (39) (6) and the social finance network platform, which can be partially resident in the computing cloud data storage, partially resident in the administrative server, and partially resident on the client device and stored therein.

In one embodiment, the social finance network administrative server or cloud data storage (1) (1a) can include computer instructions to store and display the terms and conditions/library of agreements screen (40) to the user profile account (4) in the client device (7).

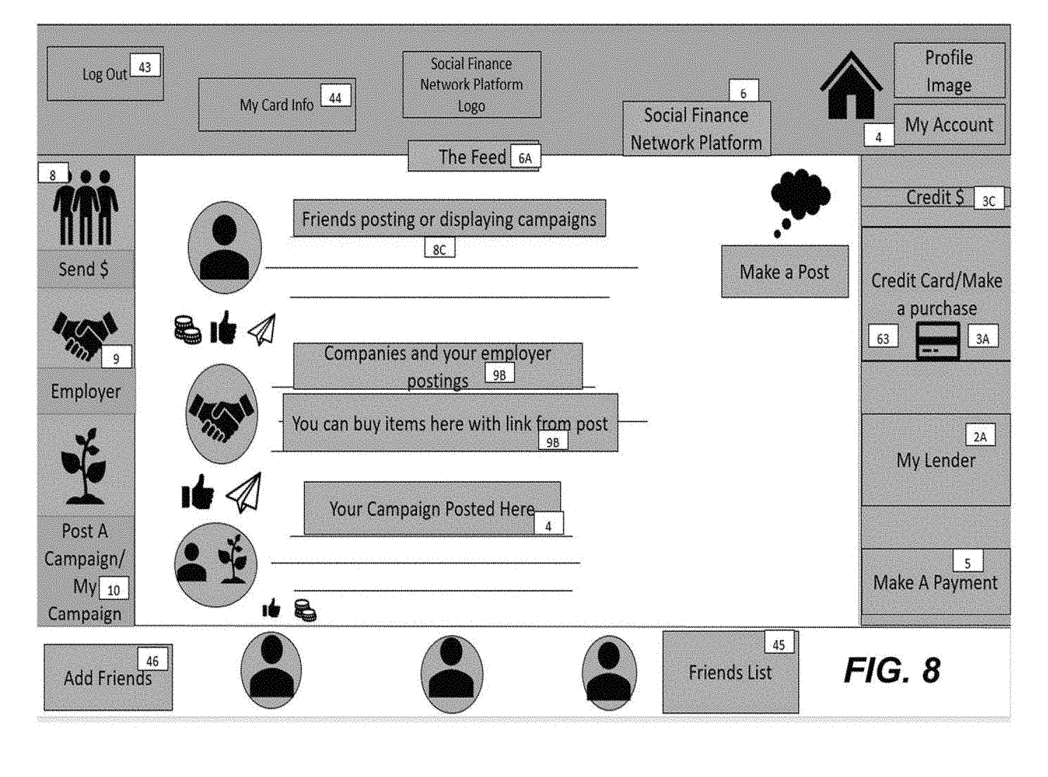

FIG. 8 depicts a landing page for a social finance network platform. In one embodiment, the social finance network platform (6) is displayed in the client device (7) for the user profile (4) exclusive to the social finance network to access to a suite of application to help them pay off their overall debt. In one embodiment, the social finance network platform (6) is displayed in the client device (7) for the user profile (4) exclusive to the social finance network to access a shopping hub of products and services that offer debt repayment incentives.

In one embodiment, the social finance network platform (6) is displayed in the client device (7) for the user profile (4) exclusive to the social finance network to access a crowdfunding tool that can be used to help pay off debt. In one embodiment, the social finance network platform (6) is displayed in the client device (7) for the user profile (4) exclusive to the social finance network to access an employment benefits tool that helps pay off debt. In one embodiment, the social finance network platform (6) is displayed in the client device (7) for the user profile (4) exclusive to the social finance network to access a community of similar people that want to pay off debt. In one embodiment, the social finance network platform (6) is displayed in the client device (7) for the user profile (4) exclusive to the social finance network to access a tool for directly paying their loan lender bills in one suite in monthly intervals. In one embodiment, the social finance network platform (6) is displayed in the client device (7) for the user profile (4) exclusive to the social finance network to access a community posting of jobs available that offer the best employment benefits that help pay off debt.

The social finance network platform (6) is displayed in the client device (7) for the user profile (4) exclusive to the social finance network to access a digital suite of similar of college students from a university that a user profile attends. In one embodiment, the social finance network platform (6) is displayed in the client device (7) for the user profile (4) exclusive to the social finance network to access a credit card that has debt repayment incentives made for the social finance network platform to purchase products and services. In one embodiment, the cloud data storage (1a) may also include the agreements link (40) (39) (6) and the social finance network platform, which can be partially resident in the computing cloud data storage, partially resident in the administrative server, and partially resident on the client device and stored therein. The user profile account (4) created exclusively for the social finance network platform (6) is given the function in their profile to view certain data such as: financial data from a credit card with debt repayment incentives (3) (63), crowdfunding (10), transfers (5), transactions (3) (5), deposits (3b), withdrawals (3b), product purchases on the profile (3d), service purchases on the profile (3d), product selling on the profile (5a), service selling on the profile (5b), university data in relation to a user profile (2b), employer data in relation to a user profile (2c), loan lender information in relation to a profile (2a), government data in relation to a profile (2d). Social security number viewing in the back end of a user profile (4c) (4d), tax data in the back end of a user profile (4c) (4d) (2d), email customization on a user profile (4c) (4d), address of a user profile (4c) (4d), a student number in accordance with that user profile's university (2b), an employment number in relation to that user profiles employer (2c) (9), an optional phone number on a user profile (4c) (4d), a it help desk number for university (2b), loan lender (2a), employer (2c) and social finance network platform (6) (4e).

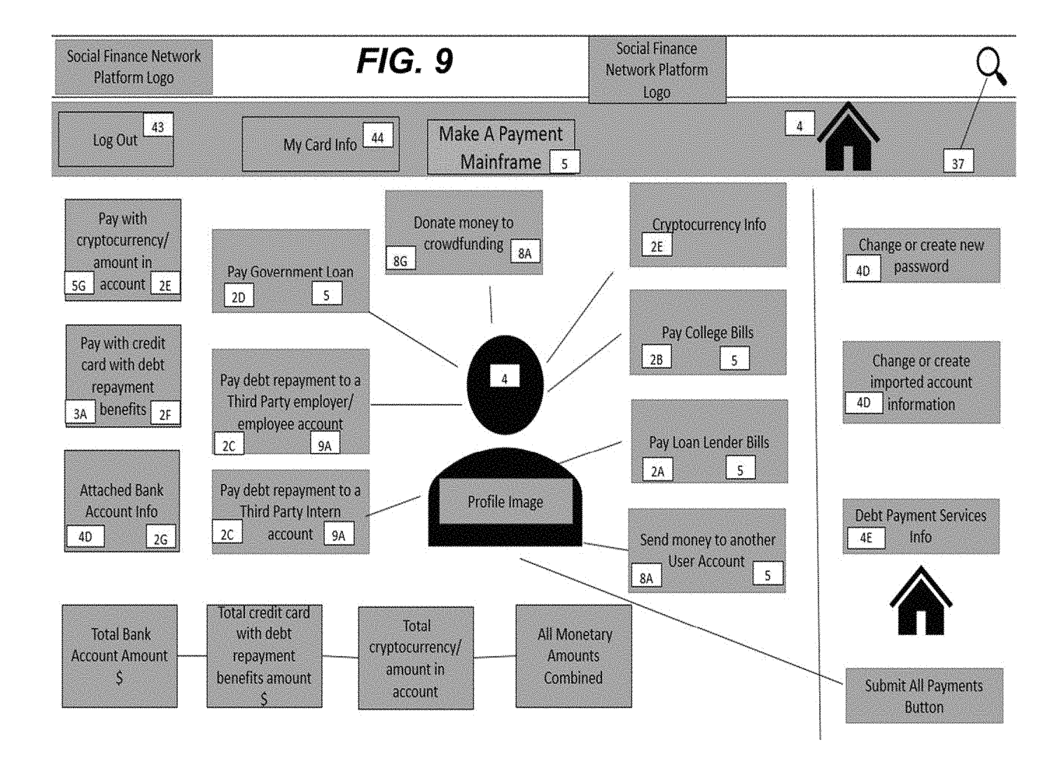

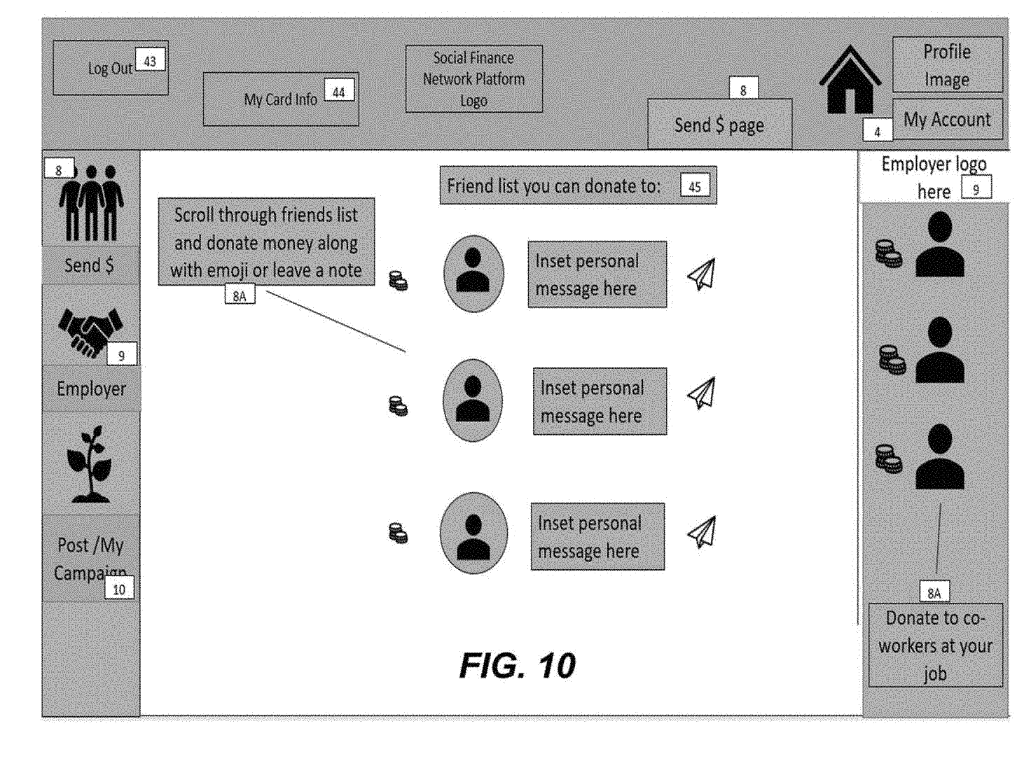

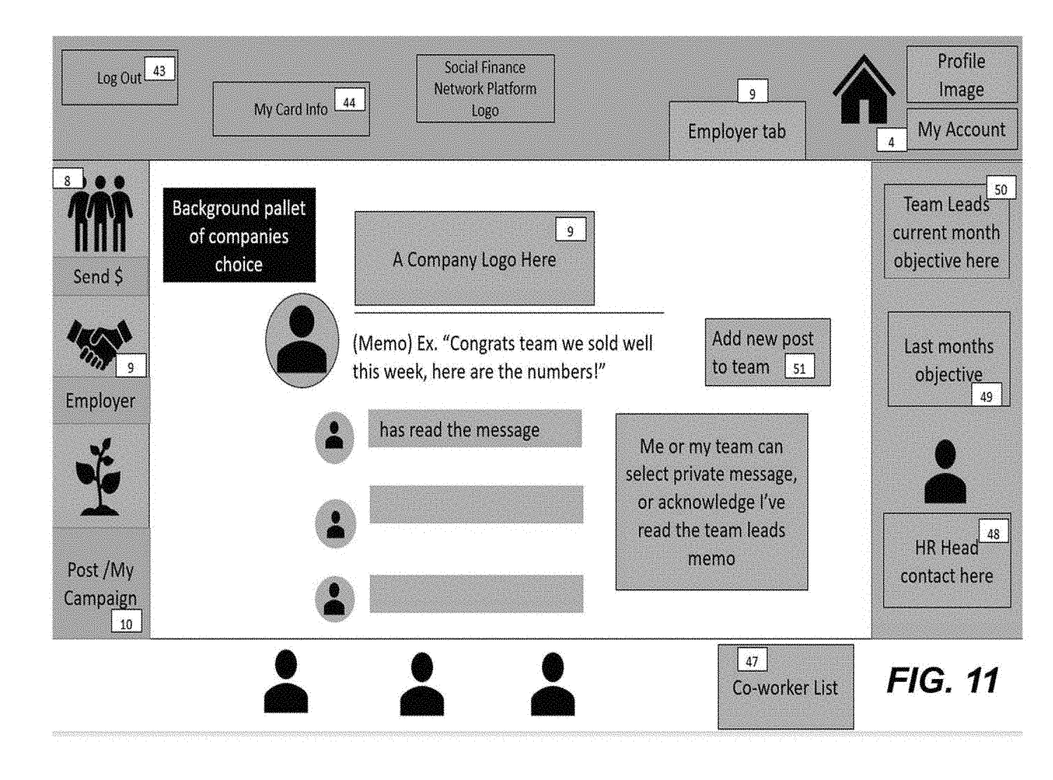

FIGS. 9, 10 and 11 depicts payment mainframe for the sending of bill payments to external servers attached to a user profile account and a send money subpage where separate user profiles, messaging transactions, transfers exist. Also, an employer subpage where co-workers, feed, management contacts and employment benefits exist in the social finance network. In one embodiment, the social finance network administrative server (1) can perform operations functions to transfer, deposit, withdraw money (11) (12) (3) (5) a user profile account exclusive to the social finance network has requested for their account to pay bills (5e), accrue employment benefits (3a) (9a), import university financial payments of any kind (2b), make a purchase (3d) (5a), sell an item (5a), purchase a service (3d) (5b), sell a service (5b), collect money from a crowdfunding campaign (10) (3b), give money to a crowdfunding campaign (10b), receive the benefits from a credit card with debt repayment benefits (3e).

In one embodiment, the social finance network administrative server (1) can execute operations functions to approve the action of adding money or monetary value into a user profile account made exclusively for the social finance network platform (6). The addition of money or monetary value being attached to a user profile account (4) made exclusively for the social finance network platform (6) can come from the following mediums: money or employment benefit from a third party employer (2c), money or monetary value given by a separate user profile account (8a) exclusive to the platform, money or monetary value from crowdfunding (10), money or monetary value given by a university for circumstances between a university admin and a user profile (2b), debt repayment incentive money or value given from purchasing (3a), selling a product on the platform (5a), debt repayment incentive money or value given from purchasing or selling a service on the platform (3a) (5b), money or value from selling a product on the platform (5a), money or value from selling a service on the platform (5b), money or value given to a user profile from a loan lender for making advanced payment on debt ahead of monthly interval schedule (2a) (4e), debt repayment incentives added to a user profile exclusively on the social finance network for using a credit card affiliated with the platform that has debt repayment incentive benefits for making purchases (3a) (63). In one embodiment, the social finance network administrative server (1) can execute operations functions to activate notices on a user profile account (4) exclusive to the social finance network platform (6). These notices include, but are not limited to, acknowledgement of approved or denied transfers (5), deposits (3b), withdrawals (5), account additions (4), university additions (2b), employment benefit addition (2c), crowdfunding additions (10), loan lender additions (2a), government additions (2d), crypto currency additions (2e), credit card additions (2f), bank additions (2g), external social media additions (2h).

In one embodiment, the social finance network user profile interface with payment mainframe and account transactions (5) (3) (4) can include computer instructions to display on the client device withdrawals (5), deposits (3b), receipts (3f), reflecting the amount of crypto currency, credit card with debt repayment benefits and bank account monetary value available (5) (5g) (3a) (4d) to date, memory record of each transaction made into the user profile account for financial analysis (3f), a time and date within the memory record of each transaction for reference in the user profile account, or combinations thereof. In one embodiment, the social finance network administrative server (1) can execute operations functions to send demonstrations or instructions to the user profile account (4) exclusive to the platform (6) on any terminal or client device (7). In one embodiment, the social finance network administrative server (1) can execute operations functions to manifest the current holdings in the user profile account in forms of money or monetary value. In one embodiment, the social finance network administrative server (1) can execute operations functions to make the user profile account (4) exclusive to the social finance network platform (6) aware of the destination transfer of payment (5) (17) (2) to a client device or terminal (7) or make said user profile account aware of destination money or monetary being received from a client device or terminal (5) (17) (2) (3). In one embodiment, the social finance network administrative server (1) can execute operations functions to allow a user profile account (4) exclusive to the social finance network platform (6) to adjust the money or monetary amount to be transferred from the account to another medium (5). In one embodiment, the social finance network administrative server (1) can execute operations functions to give the user profile account (4) exclusive to the platform to make a payment to various devices and terminals related to any payment of an outstanding bill (5) (17) (2) (7).

Operations executed by a user profile account (4) exclusive to the social finance network platform (6) can view transfers (5), withdrawals (5e) (5g) (5a) (5b), receipts (3f), deposits in an information mainframe (3) (4e). This information mainframe can display the data by date, time, month, rate at which it was made, size of the monetary value (4e). The information mainframe for transfers (5), withdrawals (5e) (5g) (5a) (5b), receipts (3f), deposits (3b) can also create an in-depth table or chart or organizational method for breaking down the bills left to pay and the amount at which that bill can be paid in monthly intervals (4e) (57) (58).

In one embodiment, the social finance network administrative server (1) can execute the operation to determine if a user profile account (4) exclusive to the social finance network platform (6) is eligible for a gifted promotion or an exclusive offer. For example, if the user profile account (4) exclusively on the social finance network platform (6) is deemed eligible for a gifted promotion or exclusive offer based on their bill payments (4e), the social finance network can send the user profile “social finance network credits” (3c) that the profile exclusive to the platform can use to purchase (3d) (5) a product or service on the platform, or put that extra monetary value towards helping pay off a bill (4e) that exists on the social finance network (1) (6) (2a). In one embodiment, the social finance network administrative server (1) can execute the operation of allowing gifted promotion and exclusive offer functions to a loan lender (2a), third party business (9) (2c), university (2b), government (2d), crypto currency (2e), credit card company (2f), bank (2g), external social media (2h) to send to a user profile account (4) exclusively on the social finance network platform (6). The operation of receiving is only executed upon the establishment that these gifted promotions and exclusive offers can only be obtained by having a user profile account (4) on the social finance network platform (6). The operation of offering gifted promotions and exclusive offers from loan lender (2a), third party business (9) (2c), university (2b), government (2d), crypto currency (2e), credit card company (2f), bank (2g), external social media (2h) can only be given on the circumstance that these offers only exist on the social finance network platform (6).

In one embodiment, the social finance network administrative server (1) can execute the operation of a user profile account (4) receiving gifted promotions or exclusive offers outside of the social finance network platform (6) if the user profile uses the credit card with debt repayment benefits (3a) (63) that is exclusively connected to the social finance network (1) (6) (4). In one embodiment, the social finance network administrative server (1) can execute the operation of a loan lender (2a), third party business (9) (2c), university (2b), government (2d), crypto currency (2e), credit card company (2f), bank (2g), external social media (2h) providing gifted promotions or exclusive offers outside of the social finance network platform (6) if the receiver of gifted promotions or exclusive offers presents their user profile account (4) exclusive to the social finance network platform (6) and performs the transaction (5) using the credit card with debt repayment benefits (3a) that is exclusively connected to the social finance network (1) (6) (4). In one embodiment, the social finance network administrative server or cloud data storage (1) (1a) can include computer instructions to automatically deposit a preset amount of money or crypto currency into any user profile account for the purpose of receiving funds or crypto currency for use with a credit card with debt repayment benefits (3) (2f), a bank account (2g), government account (2d), business or employer account (2c), intern account (2c), college student account (2b), crypto currency account (2e), loan lender account (2a), or combination of payments and receipt of funds which is used for purchases, services, refunds, or combinations thereof while exclusively on the social finance network platform or platform feed (6) (6a).

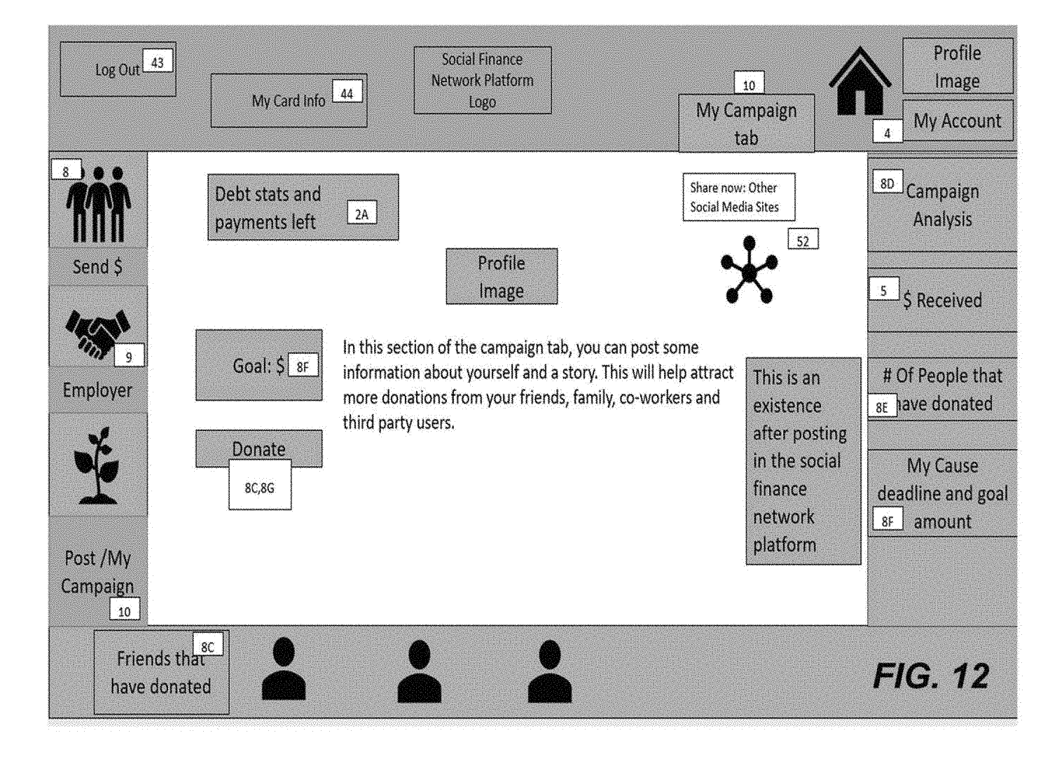

FIG. 12 depicts the crowdfunding goal screen (10a) can be presented in the social finance network platform feed (6a) interface on the client devices or devices (7). The crowdfunding goal screen (10a) can be individually manipulated (10c), allowing the user account holder to input individual goals and monitor progress towards the goals. For example, the crowdfunding goal screen (10a) can allow separate user profile accounts on the platform (8c) to send donations to any user profile account hosting a crowdfunding campaign on the social finance network platform feed (6a) (10b).

In one or more embodiments, customized achievements and data made and accumulated by saving money or reducing overall debt on a user profile account (4) (4a) (9) (61) (62) (62g) exclusively on the social finance network platform (6) can be assembled in the representation of digital graphical displays, pie charts, bar graphs, charts, tables, graphs, or any combinations thereof. The crowdfunding goal screen (10a) can be presented in the social finance network platform feed (6a) interface on the client devices or devices (7). The crowdfunding goal screen (10a) can be individually manipulated (10c), allowing the user account holder to input individual goals and monitor progress towards the goals. For example, the crowdfunding goal screen (10a) can allow separate user profile accounts on the platform (8c) to send donations to any user profile account hosting a crowdfunding campaign on the social finance network platform feed (6a) (10b).

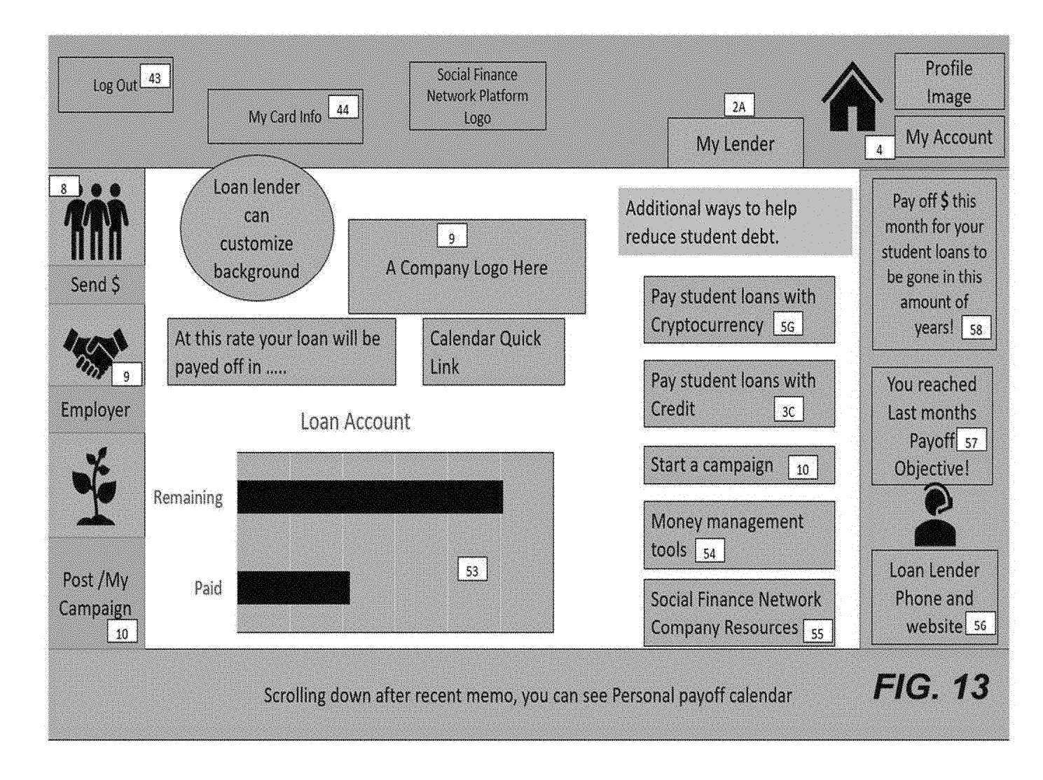

FIG. 13 depicts a student debt lender subpage for transaction and transfer directly to an outstanding loan on the social finance network. The my lender interface (2a) can present a total amount of money paid to date (53) for the associated user profile (4) receipts history (3f) of each deposit made into the account (3b) for accumulating money (5), a time and date (57) (58) for each deposit made into the account for accumulating money (2a) depicts the user profile account interface for loans presented in the client device according to one or more embodiments.

In one embodiment, the social finance network platform (6) can perform operations function to add a debt management service to a user profile (4e) account exclusive to the social finance network platform (6) for assisting in paying off debt in a certain time monthly interval (57) (58). For example, the social finance network (1) which is partially resident in the computing cloud data storage, partially resident in the administrative server, and partially resident on at least one client device can initiate an operations function to allow a user profile account (4) exclusive to the social finance network platform to perform option within debt information management with tools such as the user profile account tool to import the objectives for debt payoff in their profile (4e). The objectives tool can be debt repayment incentives and promotion accumulation exclusively from activity on the social finance network platform for assisting in payoff of debt by a selected monthly interval date, any objective related to paying for college at the cheapest price (4e) (57) (58). Any objective related to purchasing a product or service with better benefits related to paying debt (3d) (3a).

In one embodiment, the social finance network administrative server (1) can perform operations functions related to the added debt management tool on a user profile account (4e) exclusive to the social finance network platform (6) for an action to present a money amount needed to pay off a debt at monthly intervals (4e) (58). The money amount needed to pay off a debt at monthly intervals can be readjusted based on actions related to university (2b), employment benefits (2c), crowdfunding (10), transfer (5), deposit (3b), withdrawal (3b), purchases (3d), selling (5b), credit cards with debt repayment incentive (3a), loan lender (2a) or all of the above only within the social finance network platform (6).

In one embodiment, the social finance network administrative server (1) can perform operations on the platform (6) to provide a user profile (4) with an exclusive offer from the platform or gift a promotion if that user profile exclusive to the platform has gone above the amount established in monthly intervals (4e) to pay back a loan lender debt (2a). This exclusive offer or promotion gift can be set up by the network server (1), loan lender (2a), third party business (2c), university (2b), government (2d), government (2d), bank (2g), credit card company (2f), external social media (2h).

In one or more embodiments, customized achievements and data made and accumulated by saving money or reducing overall debt on a user profile account (4) (4a) (9) (61) (62) (62g) exclusively on the social finance network platform (6) can be assembled in the representation of digital graphical displays, pie charts, bar graphs, charts, tables, graphs, or any combinations thereof.

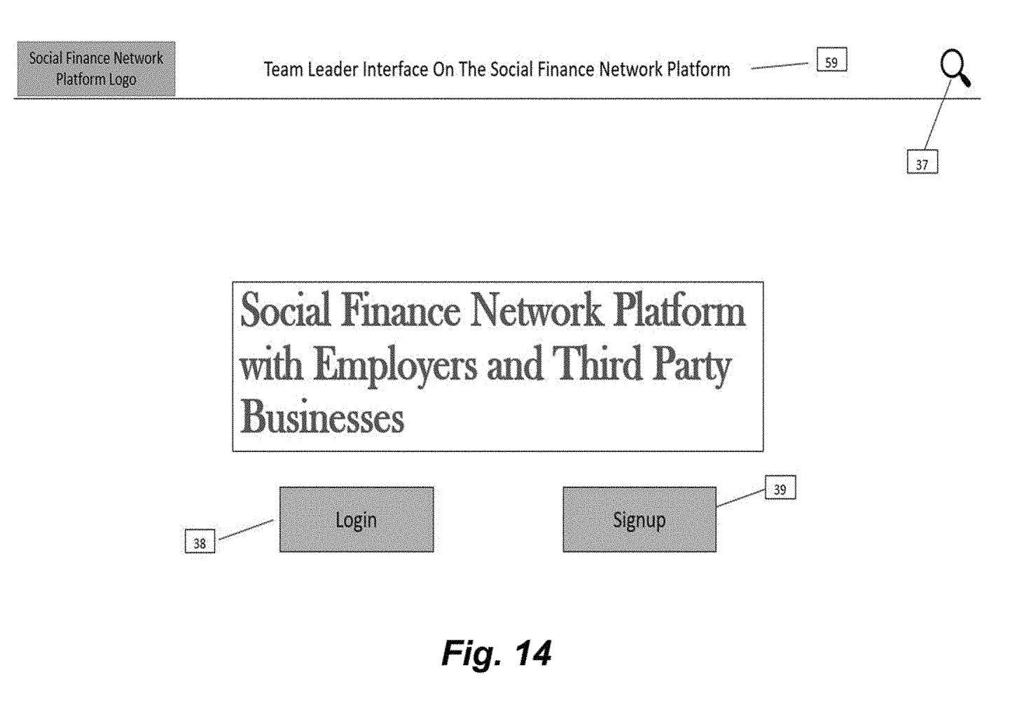

FIG. 14 depicts a login and signup mainframe for employers and HR executives to activate a team leader interface on the social finance network. A financial responsibilities agreement and other forms of agreements documentation within a team leader interface (59) (40) can be displayed within the employer account back-end information (4d) after initially agreed upon by the user profile account (4). The user agreements while operating a team leader interface section (59) (40), which will be a part of the footer of the welcome screen (36) of the social finance network (6) will present various agreements from a library of agreements (40) in one of the data storage servers. A signup agreement and other forms of agreements documentation (40) is displayed before the creation of a new user profile account with team leader interface operations (59) (41) (4) exclusively on the social finance network platform (6).

An account integration for user profile account with team leader interface operations (59) (41) (4) exclusively on the social finance network information agreement (40) is displayed upon creation of a new user profile account with team leader interface operations (59) (41) (4) exclusively on the social finance network platform (6). This account integration agreement is relative to university (2b), loan lender (2a), government (2d), third party business (2c), crypto currency (2e), credit card company (2f), bank (2g), separate social media service (2h) or all the above that will import information into the exclusive user profile account (41) (4).

An employer account with team leader interface operation (59) (4) (2c) to employee user profile (4a) (9c) for transfer of employment benefits agreement (5) (61a) is displayed upon the action of an addition where employer benefit and employer connection is made on an existing user profile account (4) exclusive to the social finance network administrative server (1). A loan lender responsibility and transfer of payment agreement (40) is displayed upon the action of an addition where third party loan lender account with team leader interface operations (59) (2a) information and other account information is uploaded and a user profile account (4) exclusive to the social finance network connection is made.

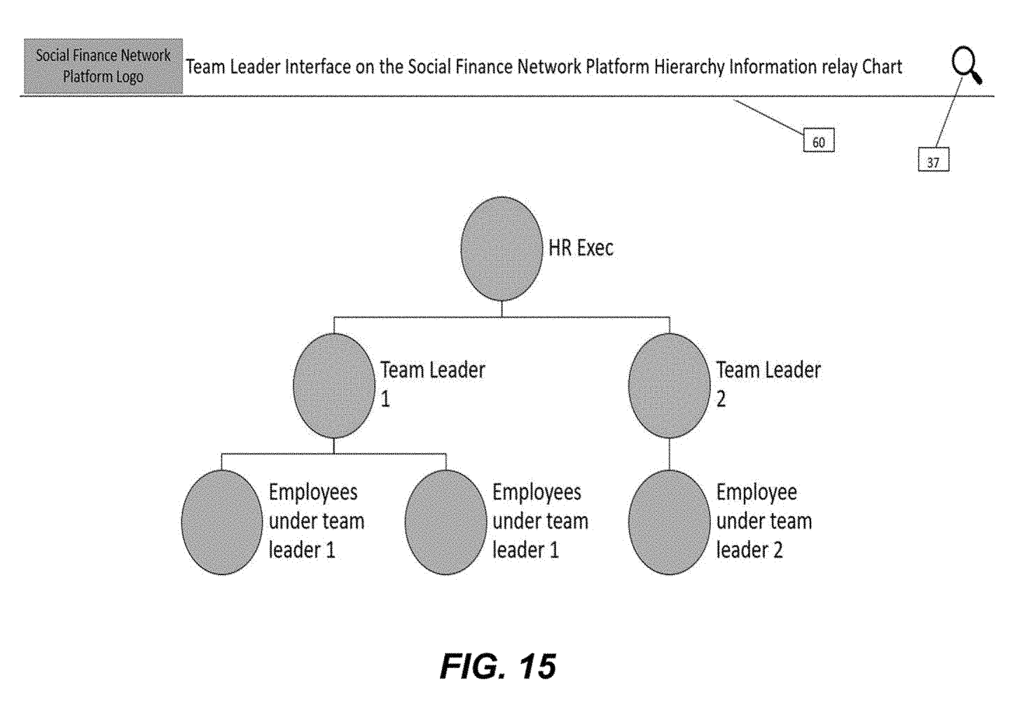

FIG. 15 depicts a management information relay chart that represents the components of a team leader interface on the social finance network.

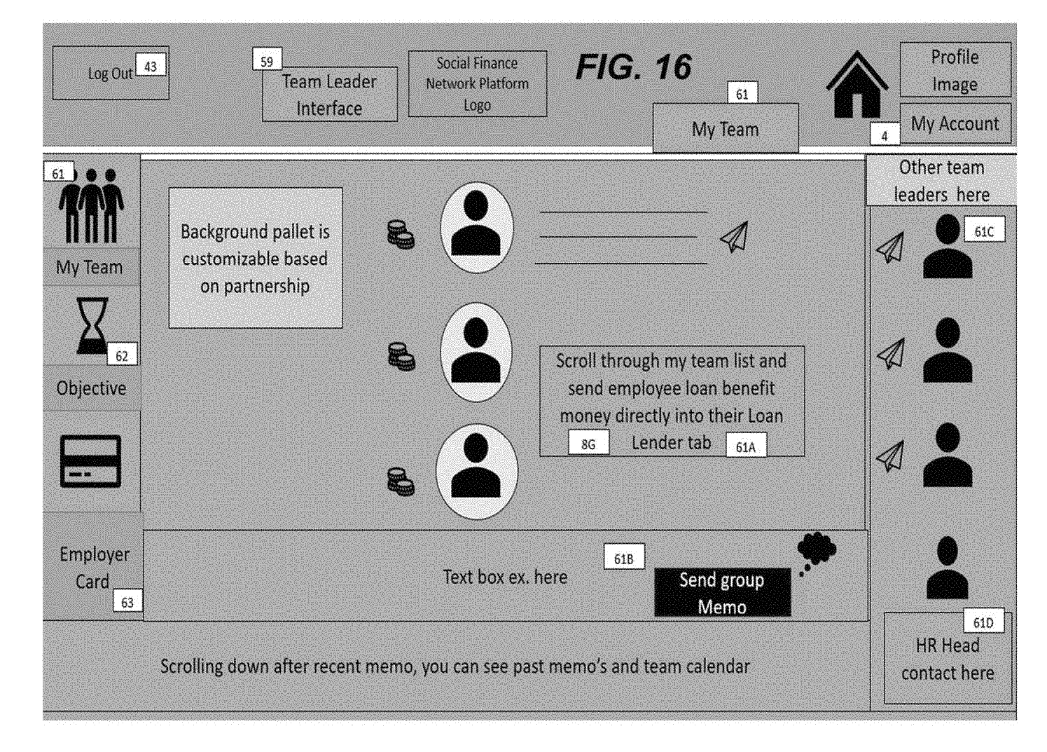

FIG. 16 depicts team leader/human resources executive subpage, wherein management, debt repayment, sending messages to employees exists in the team leader interface on social finance network. In one embodiment, the social finance network administrative server and team leader interface (59) (1) can execute operation that allow employer/HR accounts with team leader interface operation (59) (60) (61d) (61c) (4a) exclusively on the social finance network platform (6) to conduct a financial function that matches their employee's bills paid (4e) to loan lender (2a) at monthly intervals contribution, only if that employee has a user profile account (4a) (9) exclusive to the social finance network platform (6).

In one embodiment, the social finance network administrative server and team leader interface (59) (1) can perform operations functions to transfer, deposit, withdraw money (11) (12) (3) (5) a user profile account exclusive to the social finance network has requested for their account to pay bills (9) (5e), accrue employment benefits (3a) (9a), import university financial payments of any kind (2b), make a purchase (3d) (5a), sell an item (5a), purchase a service (3d) (5b), sell a service (5b), collect money from a crowdfunding campaign (10) (3b), give money to a crowdfunding campaign (10b), receive the benefits from a credit card with debt repayment benefits (3e).

In one embodiment, the social finance network administrative server and team leader interface (59) (1) can execute operations functions to approve the action of adding money or monetary value into a user profile account for employee benefits (9) made exclusively for the social finance network platform (9) (6). In one embodiment, the social finance network administrative server and team leader interface (59) (1) can execute the operation to determine if a user profile account (4) with employee benefits (9) exclusive to the social finance network platform (6) is eligible for a gifted promotion or an exclusive offer. In one embodiment, the social finance network administrative server and team leader interface (59) (1) can perform operations on the platform (6) to provide a user profile with employment benefits (9) (4) with an exclusive offer from the platform or gift a promotion if that user profile exclusive to the platform has gone above the amount established in monthly intervals (4e) to pay back a loan lender debt (2a). This exclusive offer or promotion gift can be set up by the network server (1), loan lender (2a), third party business (2c), university (2b), government (2d), government (2d), bank (2g), credit card company (2f), external social media (2h) team leader employer/HR accounts (59). In one embodiment, the social finance network administrative server and team leader interface (59) (1) can execute the operation to send a memo (61b) on the team leader interface (59) (61) if a user profile account (4) with employee benefits (9) has imported employment data into their account (4d) exclusive to the social finance network platform (6).

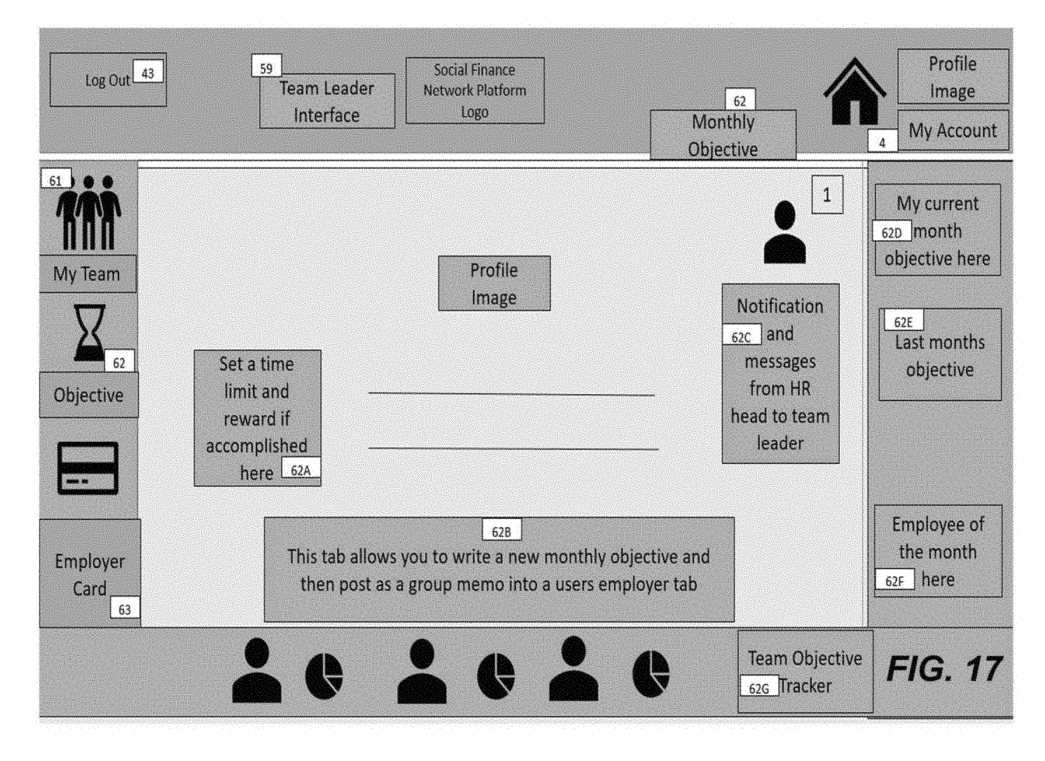

FIG. 17 depicts monthly objective subpage where team leader/human resources can post objective goals and timelines. The monthly objective goal screen on the team leader interface (62) (59) can be individually manipulated by a team leader employer/HR account (59), allowing the user account holder (59) to input individual company goals and monitor progress towards the goals with their employees that have user profile accounts (4) (9) on the social finance network platform (6). For example, the monthly objective goal screen on the team leader interface (62) (59) can allow separate user profile accounts with authorized team leader interface operation (59) on the platform (6) to send donations to any user profile account with employment benefits (4) (9) when any user profile account with employment benefits (4) (9) has completed their team objective tracker (62g).

In one or more embodiments, customized achievements and data made and accumulated by completing company objective or completing goals on a user profile account with employment benefits (4) (4a) (9) (61) (62) (62g) exclusively on the social finance network platform (6) can be assembled in the representation of digital graphical displays, pie charts, bar graphs, charts, tables, graphs, or any combinations thereof. The monthly objective goal screen on the team leader interface (62) (59) can be presented in the social finance network platform feed (6a) on the client devices or devices (7). In one embodiment, the monthly objective goal screen on the team leader interface (62) (59) can be individually manipulated (59), allowing the user account holder with team leader operations to input individual goals and monitor progress towards the goals. In one embodiment, the monthly objective goal screen on the team leader interface (62) (59) can allow separate user profile accounts with employment benefits on the platform (4) (4d) (9) (8c) to send donations to any user profile account hosting a crowdfunding campaign on the social finance network platform feed (6a) (10b).

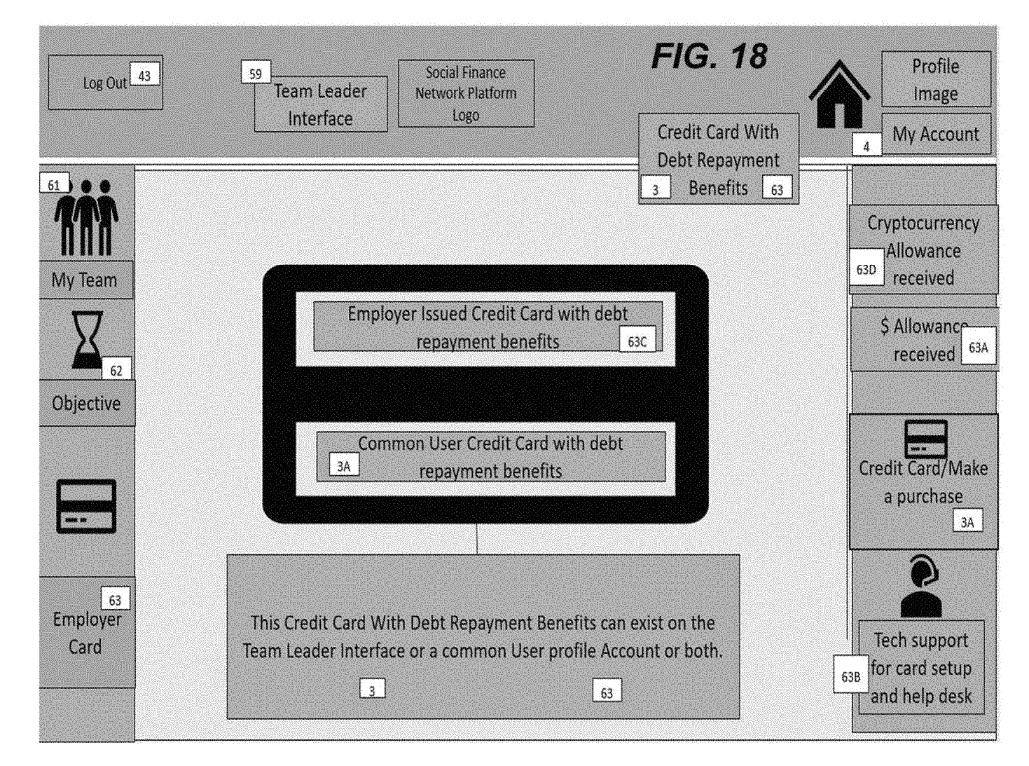

FIG. 18 depicts a subpage for an attached credit card for purchasing and debt repayment purchasing and all transfers, transaction, payments, purchases on a social finance network platform. This also demonstrates a visual representation of the credit card with debt repayment benefits for employers, employees, or common users or in combination thereof. In one embodiment, the social finance network administrative server (1) can execute operations functions for the user profile account (4) (9) (59) exclusive to the social finance network platform to choose from multiple credit card accounts added to make a purchase or pay a bill or both (3) (5a) (5b) (5e) (5f) (5g) (5h), such credit cards must be affiliated with the platform and have debt repayment incentives upon purchase or bill payment (3) (63). In one embodiment, the social finance network administrative server or cloud data storage (1) (1a) can include computer instructions to import data into a user profile account (59) (4) (4d) (9) for receiving or sending money or any forma of crypto currency from at least one credit card with debt repayment benefits (63) (3) (2f), a bank account (2g), government account (2d), business or employer account (2c), intern account (2c), college student account (2b), crypto currency account (2e), loan lender account (2a), or combinations thereof; receive data and information with regard to purchases of products or any services on the social finance network platform made using at least one credit card with debt repayment benefits (3) (2f), a bank account (2g), government account (2d), business or employer account (2c), intern account (2c), college student account (2b), crypto currency account (2e), loan lender account (2a), or in combination while in the user profile account; and create a memory record of these product or service purchases with date and time for analysis in a user profile account (4d) (3f).

The embodiments are the components of a social finance network for college students and post-grad people who have accumulated debt, student loans and school related debt which is partially resident in a social finance network administrative server and partially resident on a client device of a user profile account exclusively on the social finance network platform. In one embodiment, the social finance network platform can be accessed using a client device to log into a social finance network. In one embodiment, the social finance network administrative server can operate functions for allowing a user profile to exclusively login to the social finance network which is partially resident in a computing cloud, or in a social finance network administrative server not in a computing cloud, or combinations thereof; and partially resident on the client device using: a new user profile exclusively on the platform with a user icon and a new password. In one embodiment, the social finance network administrative server can execute operations functions to import information from third party employer, university, loan lender, government, crypto currency, credit card company, bank, external social media and transfer that collected information into a new user profile account exclusively on a social finance network. In one embodiment, the social finance network administrative server can execute operations functions to administer a credit card with debt repayment benefits in partnership with a third party credit card business exclusively to a new user profile account that is exclusively on a social finance network platform. In one embodiment, the social finance network administrative server can execute operations functions to store a user profile account exclusively on a social finance network platform to a client device that has downloaded a network application from an application marketplace.

In one embodiment, the user profile account exclusively on the social finance network platform is given the function to deposit, transfer, withdrawal money or crypto currency or both from the user profile into another account on the platform or outside the platform. In one embodiment, the user profile account exclusively on the social finance network platform with a my lender interface may include user computer instructions to compute a monetary amount needed to pay a loan bill in monthly installments in order to assess debt or complete repayment to a loan lender, with an ability to recalculate the monetary amount needed to pay a loan bill in monthly installments and provide the user a recalculated monetary amount to complete repayment to a loan lender and present this amount to a user profile account on any client device. In one embodiment, the make a payment interface on a user profile account in the social finance network platform can include electronically making or receiving payments into the user account for receipt of funds, sending bills, receiving bills, accumulating crypto currency. The deposits can include money or credit from a credit card with debt repayment benefits; money from the third party employer or business wherein user profile accounts have their loans paid off in installments while employed; money from any potential third party or another third party as an incentive or a credit card induced rebate to the student loan holder upon purchasing of an item from a third party vendor or from within the social finance platform, an additional service, or any combinations thereof; including crowdfunding payments or donations from an unknown or known contributor, personal friend, any family member, or any other party somehow connected to the social finance network user or college debt borrower; or any combinations thereof.

In an embodiment, the social finance network can operate with the cloud data storage or administrative data storage to execute functions to select the account from a plurality of accounts for transferring deposits of money into the account for purchasing, selling, paying a bill, receiving an employment benefit; provide a legal notice to any of the client devices to verify initiation of fund transfers, deposits, withdrawals, purchases or any derivative combinations thereof; and display on the client device a combination of: deposits made within certain and determined intervals by the user and the social finance network; a total amount of funds of any kind or crypto currency received from any third party and or paid to date; a continuing record of each deposit or payment made from the user profile account and registered to that account. The user profile account data will include a time and date for each deposit and disbursement made into each individual account.

In an embodiment, the social finance network can execute operations in the cloud data storage or administrative data storage to display mainframes to the user profile account exclusively on a social finance network platform via the client device or terminal. The displays can establish: a mainframe to present a terms and conditions/library of agreements, creating a user profile account, import financial information, send monetary value, make a payment, employer management, crowdfunding management, loan lender management, crypto currency management, employer team management, company objective management, credit card with debt repayments management, purchase a product or service on the social finance network, and to acquire a debt repayment incentive from that purchase of a product or service using a credit card with debt repayment benefits exclusively on the network platform, offer exclusive promotions and gifted offers, a bill mainframe, a university mainframe, a third-party employer mainframe, a social media feed mainframe, a send money and message to friends mainframe.

In one embodiment, the payment mainframe can be used by a user profile account exclusive to a social finance network platform to: pay bills to select imported external server accounts; such as government, third party employers, third party businesses, credit card accounts, crowdfunding accounts, crypto currency accounts, university accounts, loan lender accounts or separate user accounts. In the user profile account, there is the ability to pay either a late fee or a finance charge associated with paying any account fees, crowdfunding costs or late charges, including any potential early pay incentives offered by any third party or the social finance network. The social finance network shall offer third party and internal incentives from loan lenders, third party businesses, universities, government, crypto currency, credit card companies, banks, external social media or the like.

In an embodiment, the social finance network can execute operations in the cloud data storage or the administrative data storage to present to a client device: a welcome screen, login page, social finance network platform landing page, transfer money subpage, third party employer subpage, loan lender subpage, credit card with debt repayment incentives subpage, university subpage, bill paying mainframe, purchasing mainframe, selling mainframe, receiving money or monetary value mainframe, sending money or monetary value mainframe, debt management mainframe, bill paying at monthly intervals mainframe and social finance network feed.

The transfer destination for deposits, withdrawals, purchasing, selling in relation to user profile accounts exclusively on a social finance network platform can only exist if deposits, withdrawals, purchasing, selling is with a separate user profile account exclusive to the platform, third party employer, third party business, university, bank, crypto currency distributor, credit card company, loan lender, external social media, user profile with a crowdfunding campaign.

In an embodiment of the social finance network, the debt repayment process can be presented as a digital graphical display, a pie chart, a bar graph, a chart, a table, a graph, a visual display of a non-monetary goal indicator, or combinations thereof.

In an embodiment, the social finance network can include executing operations functions in the cloud data storage or administrative data storage as well as to store and provide an agreements screen from a terms and conditions/library of agreements to the new user profile account exclusive to the social finance network platform in the client device.

The login mainframe for user agreements upon creation of a new user profile account exclusive to a social finance network has components including but not limited to: a signup agreement for the user profile account acknowledging financial responsibilities; an import of financial information from loan lender, third party employer, university, government, crypto currency, third party business, bank, credit card company, external social media agreement; third party employer to user profile account agreement for transfer of employment benefits; university to user profile agreement; credit card with debt repayment incentives agreement; user to user operations agreement; transfers, withdrawals, deposits of a user profile agreement.

In an embodiment, the social finance network can execute operations functions can to create a notification and awareness systems for client devices hosting a user profile account exclusive to the social finance network platform.

In an embodiment, the social finance network platform can include using computer instructions in the data storage to enable third parties providers and lenders or vendors to provide debt repayment promotions to the user profile which includes: social finance network. Incentives to join, incentive payments, third party rebates, crowdfunding offers, crypto currency network offers, or offers of goods or services from the social finance network or third parties offered in the user profile account interface and exclusively offered through the social finance network platform or platform feed.

In an embodiment, the user profile account, exclusively on the social finance network platform can include using computer instructions in the data storage to allow linking of accounts for sending or receiving funds, including different currencies, internet payments or the like, or crypto currency to a credit card with debt repayment benefits, a bank account, crypto currency account or combinations thereof. The information associated with payments or associated purchases of products or services from a credit card (with debt repayment benefits or any company named card by the social finance network) which is used for payments or repayments of any kind, including the crypto currency account, services and purchases or combinations thereof and all such data can be transmitted to the user profile account for tracking the user profile account's transactions/or services. Such transactions may be tracked by using near field communications or global positioning services (gps), as may be approved by the social finance network and the users, or any combinations thereof.

In an embodiment, the social finance network executes operations functions in the data storage for recognition of a client device frequently hosting a user profile account exclusive to the social finance network platform.

In an embodiment, the social finance network can execute operations functions in the data storage for importing, recording and storing the data in relation to purchases of products or services being performed on the social finance network platform, the credit card with debt repayment incentives administered in partnership with third party credit card businesses made for exclusive use with the social finance network user profile account. Accessing the imported, recorded and stored data to create an algorithm or user profile account routine for use on the social finance network.

In an embodiment, the social finance network can exclusively distribute, administer, manifest, create third party credit card business partnership in relation to the creation of an exclusive credit card that offers debt repayment incentives and promotions when used to purchase products, purchase services, pay debt related bills that are on the social finance network platform or used at an authorized or exclusive terminal, university, third party business, loan lender, government, external social media, bank, credit card company, crypto currency distributor.

In an embodiment, the user profile account exclusively on the social finance network platform can include using computer instructions in the data storage to automatically or manually deposit a preset amount of funds, currencies, internet funds, transactions or crypto currency into the account for accumulating money, wherein a crypto currency related card or account is used, the credit card with debt repayment benefits, the bank account, the crypto currency account or combinations thereof, can be used for purchases, refunds, incentives or any combinations thereof that are exclusively on the social finance network platform or platform feed.

In an embodiment of the social finance network, the user profile account exclusive to the social finance network contains: a name of the user; student number for an active university student; a social security number of the user; a tax identification number of the student loan holder; an address of a user profile account; a phone number of the user profile account; an email address attached to the user profile account; security protocols for accessing a user profile account; a recovery of user account protocol; security protocol for improper or stolen access of a verified user profile account.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

### REFERENCE ELEMENTS

1. Social finance network administrative server
1a. Social finance network administrative server working with cloud data storage
2. External servers communicating with the social finance network
2a. Loan lender external servers communicating with the social finance network
2b. University external servers communicating with the social finance network
2c. Third party employer and businesses external servers communicating with the social finance network
2d. Government external servers communicating with the social finance network
2e. Cryptocurrency distributor external servers communicating with the social finance network
2f. Credit card companies external servers communicating with the social finance network
2g. Bank external servers communicating with the social finance network
2h. Social media services external servers communicating with the social finance network
3. Debt repayment benefit credit card and account transactions
3a. The debt repayment incentive credit card exclusive to the social finance network
3b. Deposits on a user profile account on the social finance network
3c. Accrued social finance network credits on a user profile
3d. Product and service purchases made by a user profile exclusive to the social finance network
3e. Accumulated amount in received incentives from the debt repayment incentive credit card.
3f. Receipts history from purchase of product and service on the social finance network
4. User profile account exclusive to the social finance network (user profile can be standalone and not attached to the following alternatives)
4a. Third party employer/employee accounts made exclusively for the platform
4b. Third party intern accounts made exclusively for the platform
4c. User profiles with attached employment accounts
4d. User profile account back-end information.
4e. User profile exclusive to the social finance network debt services
5. Payment mainframe
5a. Receiving payment from selling a product on the platform/sending payment for purchasing a product
5b. Receiving payment from selling a service on the platform/sending payment for purchasing a service
5c. Receiving payment in the form of cryptocurrency from selling a product on the platform/sending payment for purchasing a product
5d. Receiving payment in the form of cryptocurrency from selling a service on the platform/sending payment for purchasing a service
5e. Sending payment to external servers for a bill attached to the platform
5f. Receiving payment from an external server for a bill on the platform
5g. Sending payment in the form of cryptocurrency to external servers for a bill attached to the platform
5h. Receiving payment in the form of cryptocurrency from an external server for a bill on the platform
6. Social finance network platform
6a. Social finance network platform feed
6b. Promotions from university or third-party business on the social finance network feed
7. Client devices
8. Separate user profiles exclusive to the social finance network platform
8a. Send and receive monetary value from another user profile
8b. Instant messaging to another user profile
8c. Donate to specific user profile campaigns
8d. Campaign analysis
8e. Number of people that have donated
8f. My campaign deadlines
8g. Donate to specific user profile's or user profile campaigns using cryptocurrency
9. Third party employers/businesses on the social finance network platform
9a. Employment benefits for debt repayment offers
9b. Third-party business debt repayment purchase promotions on the social finance network platform feed.
9c. Management of currently employed on the platform
10. Crowdfunding
10a. User profile's posting a campaign on the social finance network platform feed
10b. User profiles donating to crowdfunding campaign
10c. User profile's commenting and posting about separate user profile crowdfunding campaign on the social finance network platform feed
11. Connecting the social finance network administrative server to a registered exclusive credit card with debt repayment incentives.
12. Connecting the social finance network administrative server to a registered exclusive credit card with debt repayment incentives to a registered exclusive user profile account.
13. Connecting the social finance network administrative server to a registered exclusive credit card with debt repayment incentives to a registered exclusive user profile account, then importing external server information into this manifested and exclusive account.
14. Social finance network administrative server connecting to a client device hosting the social finance network platform.
15. Importing all external servers, that want to conduct operation on the social finance network platform, to the social finance network administrative server.
16. Importing all external servers, that want to conduct operation on the social finance network platform, to user profile's exclusive to the network.
17. Connecting all external servers, that want to conduct operation on the social finance network platform, to a payment mainframe.
18. Connecting a user profile account exclusive to the social finance network platform to a payment mainframe.
19. Connecting a user profile account exclusive to the social finance network platform to a payment mainframe and register it with the network.
20. Registering a user profile account to the social finance network platform.
21. Connecting the social finance network platform and social finance network administrative server to the crowdfunding campaigns that exist on the network.
22. Connecting the social finance network platform and social finance network administrative server to all existing user profile accounts.
23. Registering all user profile account activity and action with the social finance network platform for user interface.
24. Connecting third-party employers/businesses to crowdfunding campaigns that exist on the social finance network.
25. Connecting third-party employers/businesses to all existing user profile accounts on the social finance network platform.
26. Cryptocurrency storage and transaction mainframe on the social finance network platform.
26a. Cryptocurrency being attached and used on the social finance network
26b. Deposits in the form of cryptocurrency on a user profile account on the social finance network
26c. Accrued cryptocurrency on a user profile from purchasing with a debt repayment credit card on the social finance network
26d. Product and service purchases made with cryptocurrency by a user profile exclusive to the social finance network
26e. Receipts history from purchase of product and service on the social finance network
26f. Special promotions from third party businesses for purchasing with cryptocurrency
27. Block chain ledger recording transaction activity on the social finance network platform
27a. Block chain ledger recording all transaction activity relative to cryptocurrency and loan lender external servers communicating with the social finance network
27b. Block chain ledger recording all transaction activity relative to cryptocurrency and university external servers external servers communicating with the social finance network
2c. Block chain ledger recording all transaction activity relative to cryptocurrency and third party employer and businesses external servers communicating with the social finance network
2d. Block chain ledger recording all transaction activity relative to cryptocurrency and government external servers external servers communicating with the social finance network
2e. Block chain ledger recording all transaction activity relative to cryptocurrency distributor external servers external servers communicating with the social finance network
2f. Block chain ledger recording all transaction activity relative to cryptocurrency and credit card companies external servers external servers communicating with the social finance network
2g. Block chain ledger recording all transaction activity relative to cryptocurrency and bank external servers external servers communicating with the social finance network
2h. Block chain ledger recording all transaction activity relative to cryptocurrency and social media services external servers communicating with the social finance network
2i. Block chain ledger recording all transaction activity relative to cryptocurrency and user to user trade on the social finance network
2j. Block chain ledger recording all transaction activity relative to cryptocurrency and crowdfunding donations on the social finance network
2k. Block chain ledger recording all transaction activity relative to cryptocurrency and using a debt repayment credit card exclusive to the social finance network
2l. Block chain ledger recording all transaction activity relative to cryptocurrency and client devices hosting a user profile account on the social finance network
28. Importing employer, college, loan lender external server information into a secure cryptocurrency storage and transaction mainframe.
29. Connecting a secure cryptocurrency storage and transaction mainframe to the social finance network platform.
30. Integrating the secure cryptocurrency storage and transaction mainframe with the payments mainframe on the social finance network platform.
31. Encryption key protocol activated upon the request for transaction using a cryptocurrency on the social finance network.
32. Set of imported information for public encrypted key for user identification when using cryptocurrency with a block chain ledger on a social finance network.
32a. User profile's account issued social finance network identity number and user name
32b. Employer account issued social finance network identity number and company consent form
32c. Crowdfunding campaign post identification number and campaign parameters on the social finance network
33. Set of imported information for private encrypted key plus a created passcode for user signature approval when using cryptocurrency with a block chain ledger on a social finance network.
33a. Third party student number for a university on a social finance network
33b. Third party employment number on a social finance network
33c. Debt repayment credit card issue serial number on a social finance network
34. A block chain added to decentralized ledger upon transaction approval with the combination of a user profiles public and private encryption key on the social finance network.
34a. User profile's account issued social finance network identity number and user name
34b. Employer account issued social finance network identity number and company consent form
34c. Crowdfunding campaign post identification number and campaign parameters on the social finance network
34d. Third party student number for a university on a social finance network
34e. Third party employment number on a social finance network
34f. Debt repayment credit card issue serial number on a social finance network
35. A cryptocurrency permitted to trade and perform transaction on the social finance network.
36. A welcome screen on the social finance network platform.
37. Search bar on the social finance network platform.
38. Login tab and check my balance tab for existing user profile accounts on the social finance network.
39. Signup for new user profile account link.
40. Terms and conditions and library of agreements for user profile account on the social finance network platform.
41. Creating a new user profile account link after accepting terms and conditions and library of agreements on the social finance network platform.
42. Save changes to a user profile account and make it public on the social finance network platform.
43. Log out of a user profile account on the social finance network platform.
44. Link to credit card with debt repayment incentives info on a user profile account in the social finance network.
45. Friends on the user profile account on the social finance network platform.
46. Add friends to the user profile account on the social finance network platform.
47. List of co-workers of a user profile account on the social finance network platform.
48. HR head of a company employing a user profile account on the social finance network platform.
49. HR head of a company employing a user profile account with previous objectives to complete on the social finance network platform.
50. HR head of a company employing a user profile account with new objectives to complete on the social finance network platform.
51. Team leader of a company employing a user profile account adding a new memo for viewing and accepting that an employee has read it on the social finance network platform.
52. Share a crowdfunding campaign on the social finance network platform to other social networks.
53. Loan payoff representation in the form of graphs.
54. Management tools added by the social finance network.
55. Link to social finance network resources help.
56. Imported loan lender help desk on the social finance network platform.
57. Payoff loans objective made by a user profile account on the social finance network.
58. Payoff objective updates from the social finance network.
59. Team leader interface for user's that are employers at a company managing user profile accounts that are employed and on the social finance network platform.
60. Team leader interface on the social finance network platform hierarchy information relay chart.
61. In the team leader interface a my team tab for an employer on the social finance network platform
61a. Send employee loan benefit money directly into their loan lender tab
61b. Send group memos
61c. Search up and send messages to other team leaders at a company
61d. Search up and send a message to the HR executive at a company
62. Objective tab within the team leader interface for employers to set goals for the company and its employees using the social finance network platform
62a. Set a time limit and reward for employees if objective is accomplished
63b. Write a new monthly objective and then post as a group memo into a user's employer tab
64c. Notification and messages from HR head to a team leader
64d. A link with the current month objective
64e. A link with last month's objective
6f. A link with employee of the month
6g. A team objective tracker to monitor company progress
63. Credit card with debt repayment benefits for a common user profile account on the social finance network platform or an employer card given by a company that has debt repayment benefits and is on the social finance network platform or both.
63a. The allowance amount to spend a company gives a team leader or HR exec account
63b. Tech support from the company or social finance network for adding a credit card to a team leader or HR exec account
63c. Visual representation of the credit card issued by a company to a team leader or HR exec account.
63d. The allowance amount in cryptocurrency to spend a company gives a team leader or HR exec account.

What is claimed is:

1. A computer and server implemented method comprising: a Social Finance Network developed for students holding student loans and post-college student loan holders to create an ecosystem that decreases the time it takes to repay a loan, increase the percentage of loans fully returned and create new applications for repayment. This is executed through a Social Finance Network administrative server connected to a network using an administrative server and an administrative data storage and partially resident on a client device and hosting the social finance network platform having a client processor and a client data storage of a user profile account with a student profile and loans accessible through the network by: a. executing computer instructions in the client device to access the Social Finance Network administrative server connected to the network; b. executing computer instructions in the client device for the user to log in to the Social Finance Network Platform that exists in a cloud server, or in the Social Finance Network server, either not in the cloud server, or in the cloud server or in combination thereof; and existing on the client device using: a social media identifier that is created within the Social Finance Network Platform and with a social media password created on the administrative server and the cloud server; c. executing computer instructions in the administrative data storage to adjoin an external loan servicer, employer, credit card and college account and import data into the Social Finance Network user profile; d. send computer instruction to a client device for access to user profile customization and password creation on the Social Finance Network platform; e. allowing access from administrative server or an external server to a client device for the user profile on the Social Finance Network platform to enable a preset function where the user profile collects money. This function exists in the client device, administrative server, external server; f. enabling access between a Social Finance Network administrative server and an external loan server for full import of the user profiles student debt information to a user profile on a client device and on the Social Finance Network Platform; g. performing computer processes in which the Social Finance Network administrative server, Social Finance Network platform and the client device hosting a user profile which enables a function on the Social Finance Network platform for the user profile to send money to a separate client device hosting a separate user profile that exclusively exist on the Social Finance Network platform; h. enabling computer functions from the Social finance Network administrative server or external server or both to a client device hosting a user profile that exclusively exist on the Social Finance Network platform where the user profile can set multiple debt repayment goals to be met for a certain date, wherein this set date formulates payment into monthly installments leading up to said certain date; i. performing computer functions from the Social Finance Network administrative server or external server or both to a client device hosting a user profile that exist exclusively on the Social Finance Network platform to attain or forward any deposits or withdrawals deemed monetary or money or both to a separate client device that hosts a separate user profile that is exclusive to the Social Finance Network platform; the sources in which attain or forward any deposits or withdrawals deemed monetary or money or both is associated with the following: debt repayment rebate from a credit card; a credit card holding a sufficient monetary amount; monetary value from a student debt repayment employee benefit program; attainment and transfer of credit card rebate amount; monetary value from any third party source; a debt repayment rebate transferred to a user profile account exclusively in existence on a Social Finance Network platform given from purchasing a product or service or both performing this purchase exclusively on a credit card; money or any monetary value from a separate user profile account exclusively on a Social Finance Network platform; money, monetary, crypto currency or significant benefits given by a user profile accounts employer that exist exclusively on a Social Finance Network platform; money or monetary value or both from a crowdfunding campaign that is hosted by a user profile account that exist exclusively on a Social Finance Network platform; money from a loan servicer to a user profile account or money from a user profile account to a loan servicer or both that exist exclusively on a Social finance Network platform; j. using the Social Finance Network administrative server or external server or both to perform algorithmic functions on a client device to acquire user profile accounts common purchasing and browsing sequences that exclusively exists on the Social Finance Network platform; such accounts common purchasing and browsing sequences that are made exclusively on the Social Finance Network platform include: sales or return or both made using a debt repayment rebate from a credit card; sales or return or both on a credit card holding a monetary amount; sales or return made with monetary value or money or both from a student debt repayment employee benefit program; sales or return or both made from a gift card; sales or return or both made using money received from any third party source; sales or return or both made using a debt repayment rebate transferred to a user profile account exclusively in existence on a Social Finance Network platform given from purchasing a product or service or both performing this purchase exclusively on a credit card; sales or return or both made using money or any monetary received from a separate user profile account exclusively on a Social Finance Network platform; sales or return or both made using money, monetary or significant benefits received by a user profile accounts employer that exist exclusively on a Social Finance Network platform; sales or return or both made using money or monetary value or both from a crowdfunding campaign that is hosted by a user profile account that exist exclusively on a Social Finance Network platform; sales or returns or both made using money from a loan servicer to a user profile account or money from a user profile account to a loan servicer or both that exist exclusively on a Social finance Network platform; k. Using the Social Finance Network administrative server or external server or both to perform mathematical equations in a client device hosting a user profile exclusively on the Social Finance Network platform to display any amount of money or monetary value saved by using the Social Finance Network and its following functions: debt repayment rebate from a credit card; a credit card holding a sufficient monetary amount; monetary value from a student debt repayment employee benefit program; attainment and transfer of credit card rebate amount; monetary value from any third party source; a debt repayment rebate transferred to a user profile account exclusively in existence on a Social Finance Network platform given from purchasing a product or service or both performing this purchase exclusively on a credit card; money or any monetary value from a separate user profile account exclusively on a Social Finance Network platform; money, monetary or significant benefits given by a user profile accounts employer that exist exclusively on a Social Finance Network platform; money or monetary value or both from a crowdfunding campaign that is hosted by a user profile account that exist exclusively on a Social Finance Network platform; money from a loan servicer to a user profile account or money from a user profile account to a loan servicer or both that exist exclusively on a Social finance Network platform; l. performing computational functions from the Social Finance Network administrative server or external server or both to a client device to manifest a payment mainframe between a user profile and an adjoined loan server's imported account information that exist exclusively on the Social Finance Network platform. Within this payment mainframe the following is presented to the user profile: the value demonstrated from repaying debt at a certain date; receiving any monetary, crypto currency or money benefits that exist exclusively from using this manifested payment mainframe on the Social Finance Network platform; promotions or unique offers presented to a user profile exclusively on the Social Finance Network platform for paying of any amount of debt prior to a suggested date or on the day of said date; using algorithmic sequences based on the user profile activity that exist on the Social Finance Network platform to determine the how to minimize damage for repaying debt past a predetermined date; using algorithmic sequences and spending data from a client device hosting a user profile account on a Social Finance Network to determine the best timetable for paying off debt; using accrued monetary value or money to pay off debt using the following functions on the Social Finance Network platform: using accrued debt repayment rebate amount from a credit card to pay off debt within the payment mainframe; a credit card holding a sufficient monetary amount to pay off debt while in the payment mainframe that is on the Social Finance Network platform; accrued monetary or money value from a student debt repayment employee benefit program used to pay debt off while on the payment mainframe that exist on the Social Finance Network Platform; accrued credit card rebate/gifts value used to pay debt off while in the payment mainframe that exist on the Social Finance Network; monetary value from any third party source that is used to pay debt off while in the payment mainframe that exist on the Social Finance Network; accrued amount from debt repayment rebate transferred to a user profile account exclusively in existence on a Social Finance Network platform given from purchasing a product or service or both performing this purchase exclusively on a credit card, this using said amount to pay off debt within the payment mainframe that exist in the Social Finance Network; money or any monetary value received from a separate user profile account used to pay debt off using the payment mainframe that exist in the Social Finance Network platform; money, monetary or significant benefits given by a user profile accounts employer that is used to pay debt off in the payment mainframe that exist exclusively on a Social Finance Network platform; accrued money or monetary value or both from a crowdfunding campaign that is hosted by a user profile account that is used to pay off debt in the payment mainframe that exist exclusively on a Social Finance Network platform; accrued money from a loan servicer to a user profile account or money from a user profile account to a loan servicer or both used to pay debt off within the payment mainframe that exist exclusively on a Social finance Network platform; m. processing actions from a Social Finance Network administrative server or external server or both to a client device hosting a user profile exclusively on a Social Finance Network platform to enable a function that allows for a user profile to view a history or current valuation of monetary worth, debt repayment or money value accumulated in the representation of notifications, calendars, table; n. processing actions from a Social Finance Network administrative server or external server or both to a client device hosting a user profile exclusively on a Social Finance Network platform to enable a function for a user profile to view transactions history in the form of a notification, calendar, table, third party hosted graph, debt repayment rebate data scroll gesture and frame or graph feature or both from a third party credit card company on a Social Finance Network platform, debt repayment employee benefit financial history in the form of a notification, scroll gesture and frame, chart or graph or scroll gesture and feature from a third party employer or company or both exclusively on a Social Finance Network platform; o. enabling action from a Social Finance Network administrative server or external server or both to a client device hosting a user profile on a Social Finance Network platform for the user profile to receive identifiers, notifications, objective rings when the following actions are processed, met, insufficient, error process or all of the above: the value demonstrated from repaying debt at a certain date; receiving any monetary or money benefits that exist exclusively on a Social Finance Network platform; Promotions or unique offers presented to a user profile exclusively on the Social Finance Network platform for paying of any amount of debt prior to a suggested date or on the day of said date; mathematical and analytical determination on how to minimize damage for repaying debt past a predetermined date; using accrued monetary value or money to pay off debt using the following functions on the Social Finance Network platform: using accrued debt repayment rebate amount from a credit card to pay off debt within the payment mainframe; a credit card holding a sufficient monetary amount to pay off debt while in the payment mainframe that is on the Social Finance Network platform; accrued monetary or money value from a student debt repayment employee benefit program used to pay debt off while on the payment mainframe that exist on the Social Finance Network Platform; accrued credit card rebate value used to pay debt off while in the payment mainframe that exist on the Social Finance Network; monetary value from any third party source that is used to pay debt off while in the payment mainframe that exist on the Social Finance Network; accrued amount from debt repayment rebate transferred to a user profile account exclusively in existence on a Social Finance Network platform given from purchasing a product or service or both performing this purchase exclusively on a credit card, this using said amount to pay off debt within the payment mainframe that exist in the Social Finance Network; money or any monetary value received from a separate user profile account used to pay debt off using the payment mainframe that exist in the Social Finance Network platform; money, monetary, crypto currency or significant benefits given by a user profile accounts employer that is used to pay debt off in the payment mainframe that exist exclusively on a Social Finance Network platform; accrued money or monetary value or both from a crowdfunding campaign that is hosted by a user profile account that is used to pay off debt in the payment mainframe that exist exclusively on a Social Finance Network platform; accrued money from a loan servicer to a user profile account or money from a user profile account to a loan servicer or both used to pay debt off within the payment mainframe that exist exclusively on a Social Finance Network platform.

2. The method of claim 1, wherein integrating the Social Finance Network administrative server and external server to enable an online system that carries out specific tasks for: I. giving access to a user profile exclusively on a Social Finance Network platform to adjoin a bank account or multiple bank accounts for ability to perform transaction, transfers, deposits, withdrawals within a Social Finance Network platform; II. Notify a User Profile on a Social Finance Network platform when transactions, transfers or other forms of trade have been activated and successfully performed; III. All monetary value or money or both transaction history performed on a User Profile is only accessible and viewable on the payment mainframe of a Social Finance Network.

3. The method of claim 1, wherein integrating the Social Finance Network administrative server and external server to enable an online system that carries out specific tasks to a client device hosting a User Profile exclusive to the Social Finance Network a platform and application suite consisting of: I. a passcode protected login screen; II. A Social Finance Network User Profile landing page consisting of a full view of suite applications; III. A my credit card and make a purchase button which enables the online system to carry out the specified task of making a product or service or both purchase through a Social Finance Network server and platform and create a viewing mainframe and subpage for demonstrating the accrued debt repayment rebate achieved through product purchases while on the platform; IV. A My Lender button which enables the online system to carry out the specified task of viewing imported information from a User Profile's adjoined account with external and third-party loan servicer; V. a make a payment button which enables the online system to carry out the specified task of forwarding the User Profile to a payment mainframe within a Social Finance Network platform and send bills to a suggested third party or a separate User Profile on the platform; VI. A send money button which enables the online system to carry out the specified task of transferring money to a separate User Profile on a Social Finance Network platform; VII. A employer button which enables the online system to carry out the specified task of creating a viewing mainframe and subpage enabling a User Profile exclusively on a Social Finance Network platform to communicate tasks, duties, view debt repayment employee benefits or any third party responsibilities within a Social Finance Network platform; VIII. A post a campaign/my campaign button which enables the online system to carry out the specified task of allowing a User Profile access to create or monitor a assembled crowdfunding campaign made to help pay off student debt or post-college related debt that exist exclusively on a Social Finance Network platform while also enabling the online system to carry out the specified task of creating a viewing mainframe for progress made on a campaign.

4. The method of claim 1, wherein integrating the Social Finance Network administrative server and external server to enable an online system that carries out specific tasks to a client device hosting a new User Profile exclusive to a Social Finance Network a platform mandates agreements to a new User Profile, where these agreements include: I. account import agreement for the new User Profile to obtain Student Loan servicer information, bank account information, product purchasing information, university attendance information, debt accumulated information, third party information, employer information for the collection and import of such information into a Social Finance Network platform; II. a signup agreement that addresses information verification, acknowledgement of User Profile and client device fiscal responsibility, verification of college attendance, verification of established debt circumstances, verification of legal age; d. a transaction exclusively on a Social Finance Network platform agreement.

5. The method of claim 1, wherein integrating the Social Finance Network administrative server and external server to enable an online system that carries out specific tasks of notification to a User Profile on a client device when said user on the platform presets customized setting in relation to the achievement of paying off any amount of debt within the platform. Notifications may be a collection of special promotions in relation to the purchasing program of receiving a debt repayment rebate with purchases made only on a credit card.

6. The method of claim 1, wherein integrating the Social Finance Network administrative server and external server to enable an online system that carries out specific tasks of allowing Universities to create a new User Profile exclusively on a Social Finance Network platform for incoming and existing students to link the college student information through the network.

7. The method of claim 1, wherein integrating the Social Finance Network administrative server and external server to enable an online system that carries out specific tasks of permitting employers to create a new user profile for all incoming and existing employees exclusively on a Social Finance Network to link employment information through the network.

8. The method of claim 1, wherein integrating the Social Finance Network administrative server and external server to enable an online system that carries out specific tasks of establishing an established points score of a User Profile exclusively on a Social Finance Network platform based upon an algorithm that plugs in the derivatives of said User Profiles purchasing routine, repayment of debt routine, activity within the platform, use of debt repayment rebate on a credit card, altruistic tendencies in relation to crowdfunding and giving money to other User Profiles on the platform. This ranking created through custom algorithm will determine unique offers in any mode given to Users on the platform.

9. The method of claim 1, wherein integrating the Social Finance Network administrative server and external server to enable an online system that carries out specific tasks to allow loan lenders, Universities, third party businesses to present promotions related to debt or saving or hiring for employment within a Social Finance Network platform in either a cloud or non cloud storage database.

10. The method of claim 1, wherein integrating the Social Finance Network administrative server and external server to enable an online system that carries out specific tasks to activate functions on a User Profile existing on a Social Finance Network platform that: I. Recording, managing, accessing any data involved with transactions of products or services or both on a client device that hosts a User Profile which uses bank accounts, credit card information and debt repayment rebate purchases, loan lender transactions on the platform, employment transactions on the platform, crowdfunding transactions on the platform; II. Harnessing the recording, managing, accessing of all transactions, bill payments, User Profile activity on the platform to construct a theorem or learning device or framework of purchasing routine, transaction routine, transfer routine, education routine, university routine, employment routine; III. Harnessing the recording, managing, accessing of all transactions, bill payments, User Profile activity on the platform to construct a promotion or positive financial activity tailored to a User Profile while on a Social finance network; IV. Harnessing the recording, managing, accessing of all transactions, bill payments, User Profile activity on the platform to construct new transaction methods for university related products being purchased exclusively on a Social Finance Network platform.

11. The method of claim 12, wherein integrating the Social Finance Network administrative server and external server to enable an online system that carries out specific tasks to activate a directive on a User Profile in a Social Finance Network platform to forward collected money or monetary value instantly from a purchase or transaction or both with a debt repayment credit card program into a User Profile's account exclusively on a Social finance network platform.

12. The method of claim 1, A User Profile created and exclusive on a Social Finance Network platform consist of the following parameters: I; Birth name or legally changed name of the owner of a User Profile; II. University Identifier tailored to said University administration within backend account information or front-end account information or both; III. A social security number attached to back end account information of a User Profile; IV. A tax identification number attached to back end account information of a User Profile; V. an email address attached to the back-end information of a User profile; VI. A cell or other type of landline phone number of the User profile account holder; VII. An email verification process for login to a User Profile account on a Social Finance Network platform while using a new or foreign or both client device; VIII. Identification of FAFSA info attached to the back-end of a User Profile account; IX. Employer security questions and other security protocols for verification of employment and approval of debt repayment employee benefits on a User Profile account on a Social Finance Network platform; X. Student debt servicer client security protocols and verification for attachment of student debt account onto a User Profile account on a Social Finance network platform; XI. Pre-chosen security verification protocols upon the lockout or security breach or both of a User Profile account on a Social finance Network platform; credit card holder security questions and protocols upon attachment of a credit card on a User Profile account on a Social Finance Network platform, credit card error, purchasing error, over drafted card error, security breach, faulty passcode lockout, unauthorized point of sale or near field communication or Social Finance Network purchases or all of the above; XII. Wherein a client device hosting a User Profile on a Social Finance Network platform enters foreign or unregistered countries, territories, provinces, cities, states and declares a transaction on the platform a pre-chosen security verification protocol is initiated upon unknown lockout, credit card error, purchasing error, over drafted card error, security breach, faulty passcode lockout, unauthorized point of sale, unauthorized near field communication payment, Social Finance Network purchases; all of the above.

13. A method for a user holding student loans to create a social finance network platform that decreases a time it takes to repay the loans, increases a percentage of loan repayment, and creates new applications for repayment, the method comprising steps:
(a) executing computer instructions via a social finance network administrative server connected to a network using an administrative server and an administrative data storage and partially resident on a client device, and hosting the social finance network platform having a client processor and a client data storage of a user profile account with a student profile and loans accessible through the network;
(b) executing computer instructions in the client device for the user to log in to the social finance network platform that exists on a cloud server, the log in comprising a social media identifier that is created within the social finance network platform and with a social media password created on the administrative server and the cloud server;
(c) executing computer instructions in the administrative data storage to adjoin an external loan servicer, employer, credit card and college account and import data into the user profile;
(d) sending computer instruction to the client device for access to user profile customization and password creation on the social finance network platform;
(e) enabling access from the administrative server to the client device for the user profile on the social finance network platform to enable a preset function where the user profile collects money;
(f) enabling access between the social finance network administrative server and an external loan server for a full import of the user profile student debt information to the social finance network platform;
(g) performing computer processes in which the social finance network administrative server, social finance network platform, and the client device hosts the user profile which enables a function on the social finance network platform for the user profile to send money to a separate client device hosting a separate user profile that exclusively exist on the social finance network platform;
(h) enabling computer functions from the social finance network administrative server to the client device hosting the user profile that exclusively exist on the social finance network platform, wherein the user profile can set multiple debt repayment goals to be met for a certain date, wherein this set date formulates payment into monthly installments leading up to the certain date;
(i) performing computer functions from the social finance network administrative server to the client device hosting the user profile that exist exclusively on the social finance network platform to attain any deposits or withdrawals deemed monetary to a second separate client device that hosts a second separate user profile that is exclusive to the social finance network platform, wherein the sources in which attain any deposits or withdrawals deemed monetary is associated with the following: debt repayment rebate from a credit card; a credit card holding a sufficient monetary amount; monetary value from a student debt repayment employee benefit program; attainment and transfer of credit card rebate amount; monetary value from any third party source; a debt repayment rebate transferred to a user profile account exclusively in existence on the social finance network platform given from purchasing a product or service or both performing this purchase exclusively on a credit card; money or any monetary value from a second separate user profile account exclusively on the social finance network platform; monetary, crypto currency or significant benefits given by a user profile accounts employer that exist exclusively on the social finance network platform; money or monetary value from a crowdfunding campaign that is hosted by a user profile account that exist exclusively on the social finance network platform; money from a loan servicer to a user profile account or money from a user profile account to a loan servicer or both that exist exclusively on the social finance network platform;
(j) performing algorithmic functions on the client device to acquire user profile accounts common purchasing and browsing sequences that exclusively exists on the social finance network platform, wherein the accounts include sales made using a debt repayment rebate from a credit card, sales on a credit card holding a monetary amount sales made with monetary value from a student debt repayment employee benefit program, sales made from a gift card, sales made using money received from any third party source, sales made using a debt repayment rebate transferred to a user profile account exclusively in existence on the social finance network platform given from purchasing a product or service or both performing this purchase exclusively on a credit card; sales or return or both made using money or any monetary received from a separate user profile account exclusively on a social finance network platform; sales made using money, monetary or significant benefits received by a user profile accounts employer that exist exclusively on the social finance network platform; sales made from a crowdfunding campaign that is hosted by a user profile account that exist exclusively on the social finance network platform, sales made from a loan servicer to a user profile account or money from a user profile account to a loan servicer that exist exclusively on the social finance network platform;
(k) performing mathematical equations in the client device hosting a user profile exclusively on the social finance network platform to display any amount of money or monetary value saved by using the social finance network and its following functions: debt repayment rebate from a credit card, a credit card holding a sufficient monetary amount, monetary value from a student debt repayment employee benefit program, attainment and transfer of credit card rebate amount, monetary value from any third party source, a debt repayment rebate transferred to a user profile account exclusively in existence on the social finance network platform given from purchasing a product or service performing this purchase exclusively on a credit card, money or any monetary value from a separate user profile account exclusively on the social finance network platform, money, monetary or significant benefits given by a user profile accounts employer that exist exclusively on the social finance network platform; money or monetary value from a crowdfunding campaign that is hosted by a user profile account that exist exclusively on a social finance network platform, money from a loan servicer to a user profile account or money from a user profile account to a loan servicer that exist exclusively on the social finance network platform;
(l) performing computational functions from the social finance network administrative server to the client device to manifest a payment mainframe between a user profile and an adjoined loan server's imported account information that exist exclusively on the social finance network platform, the payment mainframe comprises a value demonstrated from repaying debt at a certain date, receiving any monetary, crypto currency or money benefits that exist exclusively from using the payment mainframe on the social finance network platform, promotions or unique offers presented to a user profile exclusively on the social finance network platform for paying of any amount of debt prior to a suggested date or on the day of the suggested date, using algorithmic sequences based on the user profile activity that exist on the social finance network platform to determine the how to minimize damage for repaying debt past a predetermined date, using algorithmic sequences and spending data from a client device hosting a user profile account on a social finance network to determine the best timetable for paying off debt, using accrued monetary value or money to pay off debt using the following functions on the social finance network platform, using accrued debt repayment rebate amount from a credit card to pay off debt within the payment mainframe, a credit card holding a sufficient monetary amount to pay off debt while in the payment mainframe that is on the social finance network platform, accrued monetary or money value from a student debt repayment employee benefit program used to pay debt off while on the payment mainframe that exist on the social finance network platform, accrued credit card rebate/gifts value used to pay debt off while in the payment mainframe that exist on the social finance network, monetary value from any third party source that is used to pay debt off while in the payment mainframe that exist on the social finance network, accrued amount from debt repayment rebate transferred to a user profile account exclusively in existence on a social finance network platform given from purchasing a product or service performing this purchase exclusively on a credit card using the amount to pay off debt within the payment mainframe that exist in the social finance network, money or any monetary value received from a separate user profile account used to pay debt off using the payment mainframe that exist in the social finance network platform, money, monetary or significant benefits given by a user profile accounts employer that is used to pay debt off in the payment mainframe that exist exclusively on the social finance network platform, accrued money or monetary value from a crowdfunding campaign that is hosted by a user profile account that is used to pay off debt in the payment mainframe that exist exclusively on the social finance network platform, accrued money from a loan servicer to a user profile account or money from a user profile account to a loan servicer or both used to pay debt off within the payment mainframe that exist exclusively on the social finance network platform;
(m) processing actions from the social finance network administrative server to the client device hosting the user profile exclusively on the social finance network platform to enable a function that allows for the user profile to view a history or current valuation of monetary worth, debt repayment, or money value accumulated in the representation of notifications, calendars, and tables;
(n) processing actions from the social finance network administrative server to the client device hosting the user profile exclusively on the social finance network platform to enable a function for a user profile to view transactions history in the form of a notification, calendar, table, third party hosted graph, debt repayment rebate data scroll gesture and frame, or graph feature, from a third party credit card company on the social finance network platform; and,
(o) enabling action from the social finance network administrative server to the client device hosting the user profile on the social finance network platform for the user profile to receive identifiers, notifications, objective rings when the following actions are processed, met, insufficient, error process or all of the above: a value demonstrated from repaying debt at a certain date, receiving any monetary or money benefits that exist exclusively on the social finance network platform, promotions or unique offers presented to the user profile exclusively on the social finance network platform for paying of any amount of debt prior to a suggested date or on the day of said date, mathematical and analytical determination on how to minimize damage for repaying debt past a predetermined date, using accrued monetary value or money to pay off debt using the following functions on the social finance network platform: using accrued debt repayment rebate amount from a credit card to pay off debt within the payment mainframe, a credit card holding a sufficient monetary amount to pay off debt while in the payment mainframe that is on the social finance network platform, accrued monetary or money value from a student debt repayment employee benefit program used to pay debt off while on the payment mainframe that exist on the social finance network platform, accrued credit card rebate value used to pay debt off while in the payment mainframe that exist on the social finance network, monetary value from any third party source that is used to pay debt off while in the payment mainframe that exist on the social finance network, accrued amount from debt repayment rebate transferred to a user profile account exclusively in existence on a social finance network platform given from purchasing a product or service or both performing this purchase exclusively on a credit card using the amount to pay off debt within the payment mainframe that exist in the social finance network, money or any monetary value received from a separate user profile account used to pay debt off using the payment mainframe that exist in the social finance network platform, money, monetary, crypto currency or significant benefits given by a user profile accounts employer that is used to pay debt off in the payment mainframe that exist exclusively on the social finance network platform, accrued money or monetary value from a crowdfunding campaign that is hosted by a user profile account that is used to pay off debt in the payment mainframe that exist exclusively on the social finance network platform, accrued money from a loan servicer to a user profile account or money from a user profile account to a loan servicer or both used to pay debt off within the payment mainframe that exist exclusively on the social finance network platform.
